(19) United States
(12) Patent Application Publication
(10) Pub. No.: US 2026/0361462 A1
(43) Pub. Date: Nov. 12, 2026

(54) METHODS, APPARATUS, SYSTEMS, COMPUTER-READABLE STORAGE MEDIA, AND COMPUTER PROGRAM PRODUCTS OF COMMUNICATION

(71) Applicant: Huawei Technologies Co., Ltd., Shenzhen (CN)

(72) Inventors: Van Hung Vu, Ottawa (CA); Yu Cao, Ottawa (CA); Huazi Zhang, Zhejiang (CN); Haoyuan Wei, Stittsville (CA)

(21) Appl. No.: 19/699,072

(22) Filed: Jun. 5, 2026

Related U.S. Application Data
(63) Continuation of application No. PCT/CN2024/096311, filed on May 30, 2024.
(60) Provisional application No. 63/606,874, filed on Dec. 6, 2023.

(51) Int. Cl. H04L 1/00

(52) U.S. Cl. CPC H04L 1/0063

(57) ABSTRACT

Methods, apparatus, systems, computer-readable storage media, and computer program products of communication are disclosed. Harsh transmission conditions like pre-emption can affect reliability even in cross-CB coding. In this application, transmission bits such as CCBs in different transmission corresponds to different RVs, a RV can be jointly decoded with other RVs corresponding to the same mother codeword at a receiver, to obtain a better decoding gain. Thus, the transmission reliability of cross-CB coding can be improved.

### CROSS-REFERENCE TO RELATED APPLICATION

The present application is a continuation of International Patent Application No. PCT/CN2024/096311, filed on May 30, 2024, which claims the benefit of U.S. Patent Application No. 63/606,874, filed on Dec. 6, 2023. The entire contents of the aforementioned applications are hereby incorporated by reference.

### TECHNICAL FIELD

The present application relates to coding and rate-matching for wireless communications.

### BACKGROUND

In many applications of wireless communications, retransmission may be required if the data transmitted in initial transmission was not decoded successfully. Such data can be represented by a transport block (TB) in the physical layer. Further, a TB can be segmented and encoded by forward error correction (FEC) codes to generate multiple code blocks (CBs) for transmission. In fifth generation (5G) new radio (NR), low-density parity check (LDPC) code is used as the FEC code. LDPC code is a systematic code in which the CB consists of both information/systematic and parity/check bits (Here, the term “A/B” means that A and B are interchangeably equivalent). The information/systematic bits represent the data, while the parity/check bits represent the redundancy bits calculated and added by the LDPC code for error correction.

To improve the performance of transmission, multiple CBs will be retransmitted by cross-CB coding. The main idea of cross-CB coding scheme is that, after initial transmission of CBs, one can determine a set of cross-blocks from the columns of the CBs. Such cross-blocks are then encoded to generate cross-block check blocks (CCBs) by using a FEC method such as LDPC coding method, Polar coding method or Turbo coding method. At a receiver, for both systematic and non-systematic codes, the CBs from initial transmission and CCBs from retransmission are jointly decoded to effectively obtain the data.

Compared to the traditional hybrid automatic repeat request (HARQ), less times of retransmission will be needed for the cross-CB coding. However, under some harsh transmission conditions like pre-emption, even cross-CB coding will become unreliable, so improving the transmission reliability of cross-CB coding is a current problem that needs to be solved.

### SUMMARY

This application provides methods, apparatus, systems, computer-readable storage media, and computer program products of communication, to improve the transmission reliability of cross-CB coding.

This invention proposes a rate-matching procedure in HARQ retransmission. More specifically, this invention focuses on cross-CB coding with LDPC codes for retransmission in which the parity bits are generated based on multiple CBs in initial transmission and are sent in retransmission if initial transmission is decoded unsuccessfully. In each retransmission, the information/systematic bits in CBs of initial transmission are interleaved together, for example, by performing vertical segmentation (or referred to as cross segmentation). The parity bits are then generated by mother LDPC codes to generate multiple mother codewords. Based on such mother codewords and available transmission resource, one may select a redundancy version (RV) to be sent in retransmission. As such, this invention proposes rate-matching by combining interleaving of CBs and selecting the RVs from multiple LDPC mother codewords.

In a first aspect, an embodiment of this application provides a method of communication, the implementer of the method, i.e., a sender, may be a terminal, a network device, or a chip applied to a terminal or a network device. The method comprises: obtaining multiple CBs, wherein the multiple CBs comprise a first CB and a second CB, the first CB comprises a first plurality of subblocks (SBs), and the second CB comprises a second plurality of SBs; generating a first SB set according to the multiple CBs, wherein the first SB set comprises a first SB from the first plurality of SBs and a second SB from the second plurality of SBs; generating a first mother codeword according to the first SB set, wherein the first mother codeword comprises the first SB set and a first check bit set, the first check bit set is determined based on the first SB set; outputting a first bit set according to the first mother codeword, wherein the first bit set comprises a first RV of the first mother codeword.

The first check bit set may be generated based on the first SB set, by a FEC method such as LDPC coding method, Polar coding method or Turbo coding method, and the first mother codeword may be a combination of the first SB set and the first check bit set. The first RV may be a traditional RV, or a new RV different from the traditional RV. And the index of the first RV may be indicated by an indication of a sender, or may be pre-defined information. By outputting the first RV of the first mother codeword, the first RV can be jointly decoded with other RVs corresponding to the first mother codeword at a receiver, to obtain a better decoding gain. Thus, the transmission reliability of cross-CB coding can be improved.

In an optional implementation of the first aspect, the method further comprises: sending first information, wherein the first information indicates the first RV.

By the first information, a receiver may determine the RV of the current retransmission, and a sender may select different RVs in different retransmissions, so that the flexibility of retransmission in cross-CB coding can be improved.

In an optional implementation of the first aspect, the first RV starts from a first parity bit of the first mother codeword and includes a highest number of parity bits, or the first RV starts at an extended parity bit of the first mother codeword and most bits of the first RV are parity bits having degree one, or the first RV starts at the ending part of the first mother codeword and most bits of the first RV are systematic bits of the first mother codeword.

In an optional implementation of the first aspect, the method further comprises: sending second information, wherein the second information indicates the first SB set.

By the second information, a receiver may determine the first SB set of the current retransmission, and a sender may select different SB sets in different retransmissions, so that the flexibility of retransmission in cross-CB coding can be improved.

In an optional implementation of the first aspect, the generating a first SB set according to the multiple CBs, comprises: generating the first SB set according to the multiple CBs, by a first interleaver; wherein the second information indicates the first SB set, comprises: the second information indicates the first interleaver.

A sender may generate the first SB set by the first interleaver, in this case, the sender may just indicate the index of the first interleaver, compared to indicate the identifiers (IDs) of SBs in the first SB set, the amount of information that needs to be transmitted is reduced, so that the transmission resource can be saved.

In an optional implementation of the first aspect, the method further comprises: generating a second SB set according to the multiple CBs, wherein the second SB set comprises a third SB from the first plurality of SBs and a fourth SB from the second plurality of SBs; generating a second mother codeword according to the second SB set, wherein the second mother codeword comprises the second SB set and a second check bit set, the second check bit set is determined based on the second SB set; outputting a second bit set according to the second mother codeword, wherein the second bit set comprises a first RV of the second mother codeword.

In some cases, both the first CB and the second CB need to be retransmitted, a sender may generate multiple mother codewords including the second mother codeword and the first mother codeword, to improve the retransmission reliability of the first CB and the second CB.

In an optional implementation of the first aspect, the method further comprises: sending the first bit set.

In an optional implementation of the first aspect, the method further comprises: generating a third SB set according to the multiple CBs, wherein the third SB set comprises a fifth SB from the first plurality of SBs and a sixth SB from the second plurality of SBs; generating a third mother codeword according to the third SB set, wherein the third mother codeword comprises the third SB set and a third check bit set, the third check bit set is determined based on the third SB set; outputting a third bit set according to the third mother codeword, wherein the third bit set comprises a second RV of the third mother codeword.

In some cases, the first CB and the second CB need to be retransmitted again, so a sender may output the third bit set. The third bit set and the first bit set belong to different retransmissions, and the second RV may be the same as the first RV or different from the first RV, so that the flexibility of retransmission in cross-CB coding can be improved.

In an optional implementation of the first aspect, the method further comprises: sending third information, wherein the third information indicates the second RV.

By the third information, a receiver may determine the RV of the current retransmission, and a sender may select different RVs in different retransmissions, so that the flexibility of retransmission in cross-CB coding can be improved.

In an optional implementation of the first aspect, the second RV starts from a first parity bit of the third mother codeword and includes a highest number of parity bits, or the second RV starts at an extended parity bit of the third mother codeword and most bits of the second RV are parity bits having degree one, or the second RV starts at the ending part of the third mother codeword and most bits of the second RV are systematic bits of the third mother codeword.

In an optional implementation of the first aspect, the index of the second RV is the same as the index of the first RV.

In the present implementation, RVs in different retransmissions are the same, so the index of the second RV may be default information which does not need to be transmitted, so that the transmission resource can be saved.

In an optional implementation of the first aspect, the method further comprises: sending fourth information, wherein the fourth information indicates the third SB set.

By the fourth information, a receiver may determine the third SB set of the current retransmission, and a sender may select different SB sets in different retransmissions, so that the flexibility of retransmission in cross-CB coding can be improved.

In an optional implementation of the first aspect, the generating a third SB set according to the multiple CBs, comprises: generating the third SB set according to the multiple CBs, by a second interleaver; wherein the fourth information indicates the third SB set, comprises: the fourth information indicates the second interleaver.

A sender may generate the third SB set by the second interleaver, in this case, the sender may just indicate the index of the second interleaver, compared to indicate the IDs of SBs in the third SB set, the amount of information that needs to be transmitted is reduced, so that the transmission resource can be saved.

In an optional implementation of the first aspect, the method further comprises: outputting a fourth bit set according to the first mother codeword, wherein the fourth bit set comprises a third RV of the first mother codeword.

In the present implementation, the interleaving method of the first CB and the second CB is fixed in different retransmissions, so a sender may not need to generate different mother codewords in different retransmissions, and the IDs of SBs in the first SB set do not need to be transmitted either, so that the computing and transmission resources can be saved.

In an optional implementation of the first aspect, the method further comprises: sending fifth information, wherein the fifth information indicates the third RV.

By the fifth information, a receiver may determine the RV of the current retransmission, and a sender may select different RVs in different retransmissions, so that the flexibility of retransmission in cross-CB coding can be improved.

In an optional implementation of the first aspect, the third RV starts from a first parity bit of the first mother codeword and includes a highest number of parity bits, or the third RV starts at an extended parity bit of the first mother codeword and most bits of the third RV are parity bits having degree one, or the third RV starts at the ending part of the first mother codeword and most bits of the third RV are systematic bits of the first mother codeword.

In an optional implementation of the first aspect, the method further comprises: receiving sixth information, the sixth information indicates retransmitting the multiple CBs; wherein the obtaining multiple CBs, comprises: obtaining the multiple CBs, according to the sixth information.

In some cases, part of CBs in an initial transmission may be decoded correctly, so these CBs do not need to be retransmitted. In the present implementation, CBs that need to be retransmitted are determined based on the sixth information, sent by a receiver, thus, part of CBs in the initial transmission does not need to be retransmitted, so that the transmission resource can be saved.

In a second aspect, an embodiment of this application provides a method of communication, the implementer of the method, i.e., a receiver, may be a terminal, a network device, or a chip applied to a terminal or a network device. The method comprises: receiving a first bit set, wherein the first bit set comprises a first RV of a first mother codeword, the first mother codeword comprises a first SB set and a first check bit set, the first SB set comprises a first SB from a first plurality of SBs and a second SB from a second plurality of SBs, the first plurality of SBs belongs to a first CB, the second plurality of SBs belongs to a second CB, the first check bit set is determined based on the first SB set; decoding the first bit set according to the first CB and the second CB.

The first check bit set may be generated based on the first SB set, by a FEC method such as LDPC coding method, Polar coding method or Turbo coding method, and the first mother codeword may be a combination of the first SB set and the first check bit set. The first RV may be a traditional RV, or a new RV different from the traditional RV. And the index of the first RV may be indicated by an indication of a sender, or may be pre-defined information. By outputting the first RV of the first mother codeword, the first RV can be jointly decoded with other RVs corresponding to the first mother codeword at a receiver, to obtain a better decoding gain. Thus, the transmission reliability of cross-CB coding can be improved.

In an optional implementation of the second aspect, the method further comprises: receiving first information, wherein the first information indicates the first RV; the decoding the first bit set according to the first CB and the second CB, comprises: decoding the first bit set according to the first CB, the second CB and the first information.

By the first information, a receiver may determine the RV of the current retransmission, and a sender may select different RVs in different retransmissions, so that the flexibility of retransmission in cross-CB coding can be improved.

In an optional implementation of the second aspect, the first RV starts from a first parity bit of the first mother codeword and includes a highest number of parity bits, or the first RV starts at an extended parity bit of the first mother codeword and most bits of the first RV are parity bits having degree one, or the first RV starts at the ending part of the first mother codeword and most bits of the first RV are systematic bits of the first mother codeword.

In an optional implementation of the second aspect, the method further comprises: receiving second information, wherein the second information indicates the first SB set; the decoding the first bit set according to the first CB and the second CB, comprises: decoding the first bit set according to the first CB, the second CB and the second information.

By the second information, a receiver may determine the first SB set of the current retransmission, and a sender may select different SB sets in different retransmissions, so that the flexibility of retransmission in cross-CB coding can be improved.

In an optional implementation of the second aspect, the first SB set is determined by a first interleaver; the second information indicates the first SB set, comprises: the second information indicates the first interleaver.

A sender may generate the first SB set by the first interleaver, in this case, the sender may just indicate the index of the first interleaver, compared to indicate the IDs of SBs in the first SB set, the amount of information that needs to be transmitted is reduced, so that the transmission resource can be saved.

In an optional implementation of the second aspect, the method further comprises: receiving a second bit set, wherein the second bit set comprises a first RV of a second mother codeword, the second mother codeword comprises a second SB set and a second check bit set, the second SB set comprises a third SB from the first plurality of SBs and a fourth SB from the second plurality of SBs, the second check bit set is determined based on the second SB set; decoding the second bit set according to the first CB and the second CB.

In some cases, both the first CB and the second CB need to be retransmitted, a sender may generate multiple mother codewords including the second mother codeword and the first mother codeword, to improve the retransmission reliability of the first CB and the second CB.

In an optional implementation of the second aspect, the method further comprises: receiving a third bit set, wherein the third bit set comprises a second RV of a third mother codeword, the third mother codeword comprises a third SB set and a third check bit set, the third SB set comprises a fifth SB from the first plurality of SBs and a sixth SB from the second plurality of SBs, the third check bit set is determined based on the third SB set; decoding the third bit set according to the first CB, the second CB and the first bit set.

In some cases, the first CB and the second CB need to be retransmitted again, so a sender may output the third bit. The third bit set and the first bit set belong to different retransmissions, and the second RV may be the same as the first RV or different from the first RV, so that the flexibility of retransmission in cross-CB coding can be improved.

In an optional implementation of the second aspect, the method further comprises: receiving third information, wherein the third information indicates the second RV; the decoding the third bit set according to the first CB, the second CB and the first bit set, comprises: decoding the third bit set according to the first CB, the second CB, the first bit set, and the third information.

In an optional implementation of the second aspect, the second RV starts from a first parity bit of the third mother codeword and includes a highest number of parity bits, or the second RV starts at an extended parity bit of the third mother codeword and most bits of the second RV are parity bits having degree one, or the second RV starts at the ending part of the third mother codeword and most bits of the second RV are systematic bits of the third mother codeword.

In an optional implementation of the second aspect, the index of the second RV is the same as the index of the first RV.

In the present implementation, RVs in different retransmissions are the same, so the index of the second RV may be default information which does not need to be transmitted, so that the transmission resource can be saved.

In an optional implementation of the second aspect, the method further comprises: receiving fourth information, wherein the fourth information indicates the third SB set.

By the fourth information, a receiver may determine the third SB set of the current retransmission, and a sender may select different SB sets in different retransmissions, so that the flexibility of retransmission in cross-CB coding can be improved.

In an optional implementation of the second aspect, the third SB set is determined by a second interleaver; the fourth information indicates the third SB set, comprises: the fourth information indicates the second interleaver.

A sender may generate the third SB set by the second interleaver, in this case, the sender may just indicate the index of the second interleaver, compared to indicate the IDs of SBs in the third SB set, the amount of information that needs to be transmitted is reduced, so that the transmission resource can be saved.

In an optional implementation of the second aspect, the method further comprises: receiving a fourth bit set, wherein the fourth bit set comprises a third RV of the first mother codeword; decoding the fourth bit set according to the first CB, the second CB and the first bit set.

In the present implementation, the interleaving method of the first CB and the second CB is fixed in different retransmissions, so a sender may not need to generate different mother codewords in different retransmissions, and the IDs of SBs in the first SB set do not need to be transmitted either, so that the computing and transmission resources can be saved.

In an optional implementation of the second aspect, the method further comprises: receiving fifth information, wherein the fifth information indicates the third RV; the decoding the fourth bit set according to the first CB, the second CB and the first bit set, comprises: decoding the fourth bit set according to the first CB, the second CB, the first bit set, and the fifth information.

By the fifth information, a receiver may determine the RV of the current retransmission, and a sender may select different RVs in different retransmissions, so that the flexibility of retransmission in cross-CB coding can be improved.

In an optional implementation of the second aspect, the third RV starts from a first parity bit of the first mother codeword and includes a highest number of parity bits, or the third RV starts at an extended parity bit of the first mother codeword and most bits of the third RV are parity bits having degree one, or the third RV starts at the ending part of the first mother codeword and most bits of the third RV are systematic bits of the first mother codeword.

In an optional implementation of the second aspect, before the receiving a first bit set, the method further comprises: sending sixth information, the sixth information indicates retransmitting the first CB and the second CB.

In some cases, part of CBs in an initial transmission may be decoded correctly, so these CBs do not need to be retransmitted. In the present implementation, CBs that need to be retransmitted are determined based on the sixth information, sent by a receiver, thus, part of CBs in the initial transmission does not need to be retransmitted, so that the transmission resource can be saved.

In an optional implementation of the second aspect, before the receiving a first bit set, the method further comprises: receiving multiple CBs, wherein the multiple CBs comprise the first CB and the second CB.

In a third aspect, an embodiment of this application provides an apparatus of communication, the apparatus is configured to perform any method provided in the first aspect.

In a possible design, the apparatus may be divided into functional modules according to any method provided in the first aspect, each functional module may be obtained through division based on a corresponding function, or two or more functions may be integrated into one module.

For example, the apparatus may be divided into a sending module, a processing module, and the like based on functions. For descriptions of possible technical solutions and beneficial effects performed by the functional modules obtained through division, refer to the methods provided in the first aspect and the optional implementations thereof.

In a fourth aspect, an embodiment of this application provides an apparatus of communication, the apparatus is configured to perform any method provided in the second aspect.

In a possible design, the apparatus may be divided into functional modules according to any method provided in the second aspect, each functional module may be obtained through division based on a corresponding function, or two or more functions may be integrated into one module.

For example, the apparatus may be divided into a sending module, a processing module, and the like based on functions. For descriptions of possible technical solutions and beneficial effects performed by the functional modules obtained through division, refer to the methods provided in the second aspect and the optional implementations thereof.

In a fifth aspect, an embodiment of this application provides an apparatus of communication, the apparatus may be a terminal or base station (BS), or the apparatus may be a chip applied to a terminal or BS. The apparatus may comprise a processor, which is used to perform: any method provided in the first aspect and the optional implementations thereof.

Optionally, the apparatus may also comprise a transceiver. When the apparatus is a terminal or BS, the transceiver may be a transceiver circuit, an antenna, etc. When the apparatus is a chip applied to a terminal or BS, the transceiver may be an input/output interface, pin, circuit, etc.

Optionally, the apparatus may also comprise a memory for storing a computer program or instructions, and the processor executes the computer program or instructions stored in the memory to enable the apparatus to perform: any method provided in the first aspect and the optional implementations thereof. When the apparatus is a terminal or BS, the memory may be a read-only memory, random access memory, etc. When the apparatus is a chip applied to a terminal or BS, the memory may be a register, cache, etc.

In a sixth aspect, an embodiment of this application provides an apparatus of communication, the apparatus may be a terminal or BS, or the apparatus may be a chip applied to a terminal or BS. The apparatus may comprise a processor, which is used to perform: any method provided in the second aspect and the optional implementations thereof.

Optionally, the apparatus may also comprise a transceiver. When the apparatus is a terminal or BS, the transceiver may be a transceiver circuit, an antenna, etc. When the apparatus is a chip applied to a terminal or BS, the transceiver may be an input/output interface, pin, circuit, etc.

Optionally, the apparatus may also comprise a memory for storing a computer program or instructions, and the processor executes the computer program or instructions stored in the memory to enable the apparatus to perform: any method provided in the second aspect and the optional implementations thereof. When the apparatus is a terminal or BS, the memory may be a read-only memory, random access memory, etc. When the apparatus is a chip applied to a terminal or BS, the memory may be a register, cache, etc.

In a seventh aspect, an embodiment of this application provides a system of communication, the system comprises: the apparatus provided in the third aspect and the apparatus provided in the fourth aspect, or the apparatus provided in the fifth aspect and the apparatus provided in the sixth aspect.

For example, the system is a communication system, comprising at least one terminal and at least one BS.

For another example, the system is a chip system, comprising at least one processor applied in a terminal and at least one processor applied in a BS.

In an eighth aspect, an embodiment of this application provides a computer-readable storage medium, for example, a non-transitory computer-readable storage medium. The computer-readable storage medium stores a computer program or instructions. When the computer program or instructions runs on an apparatus, the apparatus is enabled to perform: any method provided in the first aspect and the optional implementations thereof, or any method provided in the second aspect and the optional implementations thereof.

In a ninth aspect, an embodiment of this application provides a computer program product, the computer program product comprises computer program code or computer program instructions, when the computer program code or the computer program instructions executed by an apparatus, the apparatus is enabled to perform: any method provided in the first aspect and the optional implementations thereof, or any method provided in the second aspect and the optional implementations thereof.

The apparatus, the system, the computer-readable storage medium, and the computer program product provided in embodiments of this application are all configured to perform the corresponding method provided above. Therefore, for advantageous effects that may be achieved by the apparatus, the system, the computer-readable storage medium, and the computer program product, refer to the advantageous effects of the corresponding method provided above. Details are not described herein again.

### BRIEF DESCRIPTION OF THE DRAWINGS

For a more complete understanding of the present embodiments, and the advantages thereof, reference is now made, by way of example, to the following descriptions taken in conjunction with the accompanying drawings.

FIG. 1 is a simplified schematic illustration of a communication system;

FIG. 2 is a block diagram illustration of the example communication system in FIG. 1;

FIG. 3 illustrates an example of electronic device and examples of base stations;

FIG. 4 illustrates units or modules in a device;

FIG. 5 illustrates an example of cross-CB coding method;

FIG. 6 illustrates an example of cross-CB coding method with SB-interleaver;

FIG. 7 illustrates an example of 5G NR coding chain and cross-CB coding chain;

FIG. 8 illustrates a method of communication;

FIG. 9 illustrates an example of the starting position of RV1 located in the circular buffer;

FIG. 10 illustrates an example of combining systematic/information bits of CBs in initial transmission and parity bits of CCBs in retransmission;

FIG. 11 illustrates an example of starting points of RV1 and RV2 and RV3 in circular buffer for LDPC BG1;

FIG. 12 illustrates a scenario that the method 800 may be applied to;

FIG. 13 illustrates another scenario that the method 800 may be applied to;

FIG. 14 illustrates another scenario that the method 800 may be applied to;

FIG. 15 is a schematic diagram of structures of a communication apparatus;

FIG. 16 is another schematic diagram of structure of a communication apparatus.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

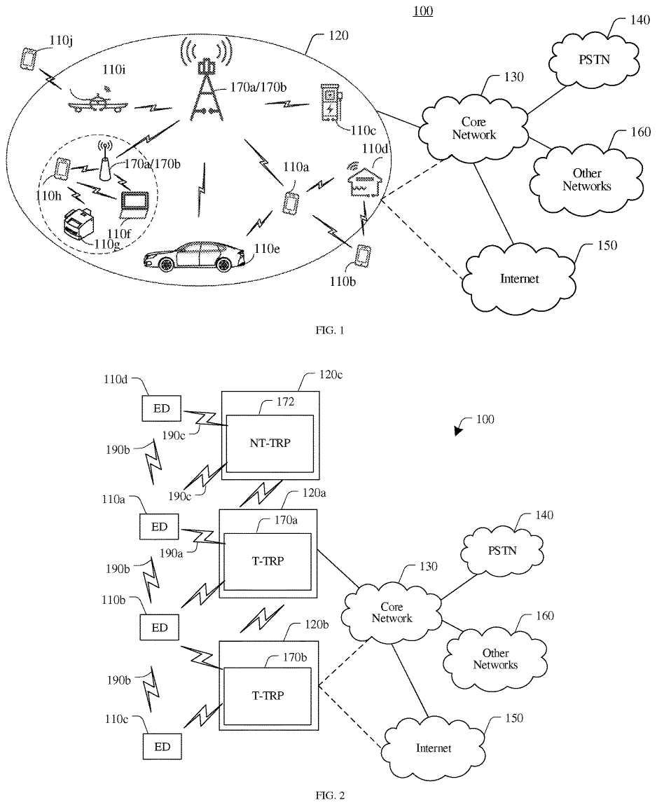

Referring to FIG. 1, as an illustrative example without limitation, a simplified schematic illustration of a communication system is provided. The communication system 100 comprises a radio access network 120. The radio access network 120 may be a next or future generation radio access network, or a legacy (e.g. 5G, 4G, 3G or 2G) radio access network. One or more communication electronic devices (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

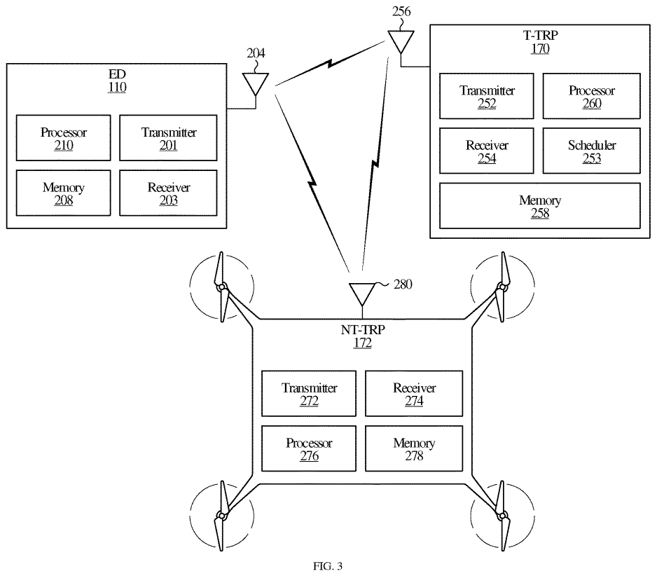

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast, groupcast, unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150, and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a,170b and NT-TRP 172, the Internet 150, the core network 130, the PSTN 140, the other networks 160, or any combination of the preceding. In some examples, ED 110a may communicate an uplink and/or downlink transmission over a terrestrial air interface 190a with T-TRP 170a. In some examples, the EDs 110a, 110b, 110c, and 110d may also communicate directly with one another via one or more sidelink air interfaces 190b. In some examples, ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA, also known as discrete Fourier transform spread OFDMA, DFT-s-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the Internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

FIG. 3 illustrates another example of an ED 110 and a base station 170a, 170b and/or 170c. The ED 110 is used to connect persons, objects, machines, etc. The ED no may be widely used in various scenarios including, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED no represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus in (e.g. communication module, modern, or chip) or comprising the foregoing devices, among other possibilities. Future generation EDs no may be referred to using other terms. The base station 170a and 170b is a T-TRP and will hereafter be referred to as T-TRP 170. Also shown in FIG. 3, a NT-TRP will hereafter be referred to as NT-TRP 172. Each ED no connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated to avoid congestion in the drawing. One, some, or all of the antennas 204 may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices or interfaces permit interaction with a user or other devices in the network. Each input/output device or interface includes any suitable structure for providing information to or receiving information from a user, and/or for network interface communications. Suitable structures include, for example, a speaker, microphone, keypad, keyboard, display, touch screen, etc.

The ED 110 includes the processor 210 for performing operations including those operations related to preparing a transmission for uplink transmission to the NT-TRP 172 and/or the T-TRP 170; those operations related to processing downlink transmissions received from the NT-TRP 172 and/or the T-TRP 170; and those operations related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g. beam angle information (BAI), received from the T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201, and the processing components of the receiver 203 may each be implemented by the same or different one or more processors that are configured to execute instructions stored in a memory (e.g. in the memory 208). Alternatively, some or all of the processor 210, the processing components of the transmitter 201, and the processing components of the receiver 203 may each be implemented using dedicated circuitry, such as a programmed field-programmable gate array (FPGA), an application-specific integrated circuit (ASIC), or a hardware accelerator such as a graphics processing unit (GPU) or an artificial intelligence (AI) accelerator.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 170 may refer to the foregoing devices or refer to apparatus (e.g. a communication module, a modem, or a chip) in the foregoing devices.

In some embodiments, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some embodiments, the T-TRP 170 may actually be a plurality of T-TRPs that are operating together to serve the ED 110, e.g. through the use of coordinated multipoint transmissions.

The T-TRP 170 includes at least one transmitter 252 and at least one receiver 254 coupled to one or more antennas 256. Only one antenna 256 is illustrated to avoid congestion in the drawing. One, some, or all of the antennas 256 may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to the NT-TRP 172, and processing a transmission received over backhaul from the NT-TRP 172. Processing operations related to preparing a transmission for downlink or backhaul transmission may include operations such as encoding, modulating, precoding (e.g. multiple input multiple output (MIMO) precoding), transmit beamforming, and generating symbols for transmission. Processing operations related to processing received transmissions in the uplink or over backhaul may include operations such as receive beamforming, demodulating received symbols, and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates an indication of beam direction, e.g. BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Signaling may be transmitted in a physical layer control channel, e.g. a physical downlink control channel (PDCCH), in which case the signaling may be known as dynamic signaling. Signaling transmitted in a downlink physical layer control channel may be known as Downlink Control Information (DCI). Signaling transmitted in an uplink physical layer control channel may be known as Uplink Control Information (UCI). Signaling transmitted in a sidelink physical layer control channel may be known as Sidelink Control Information (SCI). Signaling may be included in a higher-layer (e.g., higher than physical layer) packet transmitted in a physical layer data channel, e.g. in a physical downlink shared channel (PDSCH), in which case the signaling may be known as higher-layer signaling, static signaling, or semi-static signaling. Higher-layer signaling may also refer to Radio Resource Control (RRC) protocol signaling or Media Access Control-Control Element (MAC-CE) signaling.

The scheduler 253 may be coupled to the processor 260. The scheduler 253 may be included within or operated separately from the T-TRP 170. The scheduler 253 may schedule uplink, downlink, sidelink, and/or backhaul transmissions, including issuing scheduling grants and/or configuring scheduling-free (e.g., “configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252, and the processing components of the receiver 254 may each be implemented by the same or different one or more processors that are configured to execute instructions stored in a memory, e.g. in the memory 258. Alternatively, some or all of the processor 260, the scheduler 253, the processing components of the transmitter 252, and the processing components of the receiver 254 may be implemented using dedicated circuitry, such as a programmed FPGA, a hardware accelerator (e.g., a GPU or AI accelerator), or an ASIC.

Although the NT-TRP 172 is illustrated as a drone only as an example, the NT-TRP 172 may be implemented in any suitable non-terrestrial form, such as satellites and high altitude platforms, including international mobile telecommunication base stations and unmanned aerial vehicles, for example. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated to avoid congestion in the drawing. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating received symbols, and decoding received symbols. In some embodiments, the processor 276 implements the transmit beamforming and/or receive beamforming based on beam direction information (e.g. BAI) received from the T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272, and the processing components of the receiver 274 may each be implemented by the same or different one or more processors that are configured to execute instructions stored in a memory, e.g. in the memory 278. Alternatively, some or all of the processor 276, the processing components of the transmitter 272, and the processing components of the receiver 274 may be implemented using dedicated circuitry, such as a programmed FPGA, a hardware accelerator (e.g., a GPU or AI accelerator), or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

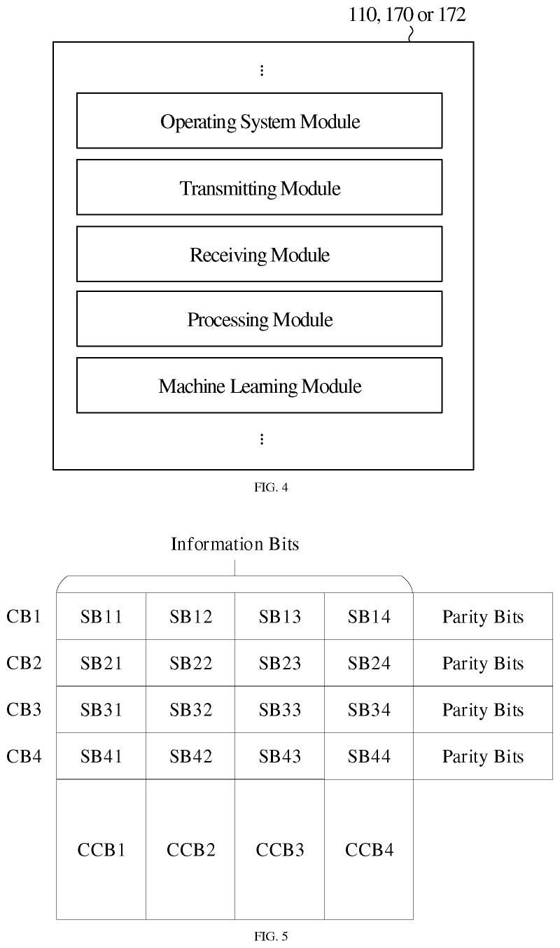

One or more steps of the embodiment methods provided herein may be performed by corresponding units or modules, according to FIG. 4. FIG. 4 illustrates units or modules in a device, such as in the ED 110, in the T-TRP 170, or in the NT-TRP 172. For example, a signal may be transmitted or output by a transmitting unit or by a transmitting module. A signal may be received or input by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be a circuit such as an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation.

While not shown, the transmitting module and the receiving module may be part of, or combined into, a transceiver module. A transceiver module may also be known as an interface module, or simply an interface, for inputting and outputting operations.

Additional details regarding the EDs 110, the T-TRP 170, and the NT-TRP 172 are known to those of skill in the art. As such, these details are omitted here.

For ease of understanding of the embodiments of this application, a brief introduction to the technologies involved in the embodiments is given first.

### 1. Cross-CB Coding.

The cross-CB coding scheme was recently developed for retransmission/HARQ. The main idea of cross-CB coding scheme is that, after initial transmission of CBs, one can determine a set of cross-blocks from the columns of the CBs. Such cross-blocks are then encoded to generate CCBs by using a FEC method such as LDPC coding method, Polar coding method or Turbo coding method and retransmit to the receiver. In initial transmission, the CBs may be in a systematic form in which each CB includes information/systematic and parity bits. In this case, the data is represented in the information/systematic bits, and the CCBs are determined from the information/systematic parts of the CBs. Alternatively, if the CBs are encoded by a non-systematic code in which the data are not contained, the CCBs are determined from the entire CBs. At the receiver, for both systematic and non-systematic codes, the CBs from initial transmission and CCBs from retransmission are jointly decoded via soft-combining to effectively obtain the data.

In FIG. 5, we illustrate an example of generating 4 CCBs from 4 coded blocks (CBs) from 4 CBs used in initial transmission. In this example, a systematic code is adopted at the CBs, so each CB consists of information and parity bits. As aforementioned, the information bits basically represent the data, while parity bits represent the redundancy bits added by a FEC method for error correction in initial transmission. Similarly, the CCB includes the parity bits generated by a FEC method in retransmission. In this example, the information bits of code block CBn, n=1, . . . , 4, is divided into 4 subblocks {SBn1, SBn2, SBn3, SBn4}, and the cross-block check block CCBm, m=1, . . . , 4, is generated from 4 SBs {SB1m, SB2m, SB3m, SB4m}.

### 2. Subblock-Interleaver.

In the case of multiple retransmissions, different interleavers can be used in each retransmission to generate a separate set of CCBs in each retransmission such that the decoding results at the receiver can be improved with more retransmissions. For instance, a subblock (SB) interleaver design has been proposed for an efficient signaling scheme. More specifically, before the vertical segmentation (or referred to as cross segmentation), each CB is (almost) equally divided into multiple SBs. In some cases, the number of bits in a CB may not be divisible by the number of SBs, so approximation can be made. For example, if the CB consists of 25 bits and is divided into 4 SBs, the first 3 SBs can include 6 bits, while the remaining SB can include 7 bits. A cyclic-shift operation can then be performed at the SB level within the SBs of a CB by a different amount in each retransmission. With the knowledge of the correspondence between a RV index and a set of SB-interleaver designs at the receiver, only the RV index needs to be signaled by the transmitter. The receiver knows the set of SB-interleavers used by the transmitter to generate the CCBs through the received SB-interleaver index. The knowledge of the correspondence between a SB-interleaver index and a set of SB-interleaver designs may be specified in a wireless cellular communication standard and stored in the receiver, or may be signaled by the transmitter.

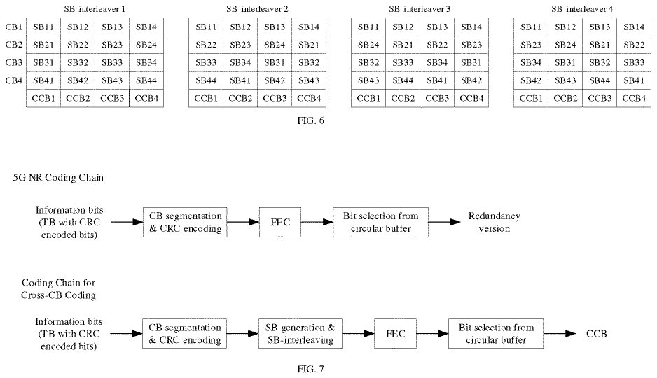

In FIG. 6, we illustrate an example of subblock-interleaver for 4 CBs and 4 CCBs with overall 4 sets of CCBs being generated. As a result, different sets of CCBs corresponding to subblock-interleaver index can be used in the first 4 retransmissions. Beyond 4th retransmission, one can select any SB-interleaver index from the set of 4 SB-interleaver indexes. It follows that some retransmissions may use the same SB-interleaver index, while other retransmissions have different SB-interleaver indexes.

### 3. Coding Chain.

In FIG. 7, we demonstrate an example of coding chains for 5G NR (i.e., in absent of cross-CB coding) and cross-CB coding. In 5G NR coding, a TB (with CRC encoded bits) is first segmented into multiple CBs. Each CB is then passed to a FEC module to perform LDPC encoding according to a pre-defined mother code rate, and the output of FEC module is the mother codeword. Such mother codeword is then written into a circular buffer, and a redundancy version (for each CB) can then be read from the circular buffer. Here, rate-matching may refer to bit selection procedure from the circular buffer. When cross-CB coding is employed, a module comprising of SB generation to generate the cross-blocks and SB interleaving to interleave the SBs in the cross-block may be added between the modules of CB segmentation and CRC encoding and FEC in NR coding chain. Given the SB-interleaver index, for cross-CB coding, rate-matching may also refer to the bit selection procedure from the circular buffer. For cross-CB coding, the output after bit selection from circular buffer is the CCB for each cross-block.

### 4. RV.

In 5G NR, traditional HARQ incremental redundancy (IR) with LDPC codes are used for retransmission. Specifically, each CB is first encoded by LDPC codes under a mother code rate (CR) to obtain a mother codeword. Based on and effectively CR and correspondingly the amount of transmission resource, a subset of bits of mother codeword, referred to as a redundancy version (RV), is selected for transmission. Such a process is generally referred to as rate-matching.

In NR LDPC code, four different redundancy versions (RVs) including NR RV0, NR RV1, NR RV2 and NR RV3 are generated from the rate matching. Note that, hereafter, we shall use the term NR RV to refer to the RV in 5G NR. In initial transmission, NR RV0 is normally selected because most of the systematic bits are included in the coded bits of NR RV0. In retransmission, the transmitter may select either NR RV0, NR RV1, NR RV2 or NR RV3. In 5G NR, the bits of NR RV0, NR RV1, NR RV2 and NR RV3 are determined as follows.

The coded bits in a mother codeword are first written into a circular buffer. The length of such circular buffer is identical to the number of coded bits in the mother codeword. In 5G NR, the beginning position of each RV is defined for each LDPC base-graph (BG). Given the number of coded bits in a RV or the length of RV, one starts to select the bits from the beginning position, wraps around following in a clock-wise direction, and restarts from the beginning of the buffer once it reaches the last bit in the buffer (accordingly, mother codeword). Here, NR RV0 starts from the first point in circular buffer, thus NR RV0 would include all systematic bits of the mother codeword. NR RV3 starts from the end of circular buffer and it also includes most of the information bits. Meanwhile, NR RV1 and NR RV2 would include most of parity bits and optionally some information bits. In traditional HARQ IR scheme, NR RV0 is usually transmitted in initial transmission. If a retransmission is required, transmitter may select any NR RV to send in retransmission. The NR RV in traditional HARQ IR scheme of 5G NR is generated separately for each CB, i.e., the transmission and retransmission are performed on the basis of a CB.

Compared to the traditional HARQ IR, the transmission reliability of the cross-CB coding has been enhanced, so less times of retransmission will be needed for the cross-CB coding. However, under some harsh transmission conditions like pre-emption, even cross-CB coding will become unreliable, so improving the transmission reliability of cross-CB coding is a current problem that needs to be solved.

With reference to the accompanying drawings, the following describes the technical solutions provided in embodiments of this application.

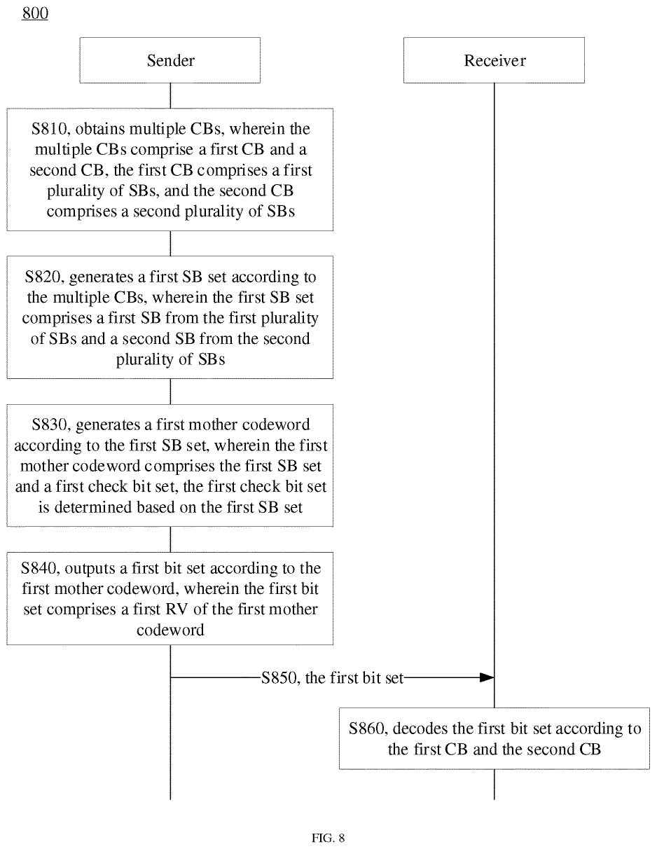

FIG. 8 is a schematic diagram illustrating a method of communication according to embodiments.

In the method 800, the sender may be any device or chip that supports wireless communication, such as a BS or an UE illustrated in FIG. 1, or chips applied on the BS or the UE. The receiver may also be any device or chip that supports wireless communication, such as a BS or an UE illustrated in FIG. 1, or chips applied on the BS or the UE. The forms of the sender and the receiver are not restricted in any embodiment of this application.

The sender and the receiver may be connected through a wireless network, for example, the sender and the receiver may be connected through a terrestrial network or a non-terrestrial network. It is understood that the sender and the receiver may alternatively be connected through other wireless network. There are no restrictions herein.

With reference to FIG. 8, the method 800 comprises:

S810, the sender obtains multiple CBs, wherein the multiple CBs comprise a first CB and a second CB, the first CB comprises a first plurality of SBs, and the second CB comprises a second plurality of SBs.

The multiple CBs means at least two CBs, which may correspond to one or more traffic streams.

For example, the multiple CBs may include the bits of a stream of enhanced mobile broadband (eMBB) traffic, wherein the first CB and the second CB include the bits of the stream of VR traffic. For another example, the multiple CBs may include the bits of a stream of VR traffic and a stream of UCI traffic, wherein the first CB includes the bits of the stream of VR traffic and the second CB includes the bits of the stream of UCI traffic. There are no restrictions for the content of the multiple CBs.

“The sender obtains multiple CBs” may also be described as “The sender determines multiple CBs”.

The sender may determine the multiple CBs by itself, alternatively, it may determine the multiple CBs based on information from other apparatus. There are no restrictions on how the sender obtains the multiple CBs.

For example, after the multiple CBs be transmitted in an initial transmission, the sender may determine that the multiple CBs need to be retransmitted, according to configuration information, wherein the configuration information configures the sender to retransmit the multiple CBs without receiving a response from a receiver. The configuration information may be information that configured by the manufacturer of the sender, alternatively, the configuration information may be information that received from other apparatus like a BS.

For another example, after several CBs be transmitted in an initial transmission, the sender may determine that the multiple CBs need to be retransmitted, according to information from a receiver, wherein the information indicates the multiple CBs in the several CBs. This information may be named as sixth information, if the multiple CBs are all of the several CBs, the sixth information may be a negative acknowledgement (NACK), if the multiple CBs are part of the several CBs, the sixth information may be IDs of the multiple CBs, such as IDs of the first CB and the second CB. In the later case, part of CBs in an initial transmission are decoded correctly, so these CBs do not need to be retransmitted, so that the transmission resource can be saved.

After obtaining the multiple CBs, the sender may perform S820 below.

S820, the sender generates a first SB set according to the multiple CBs, wherein the first SB set comprises a first SB from the first plurality of SBs and a second SB from the second plurality of SBs.

The first SB set may be one or more bit sequences, one or more bit groups, one or more bit blocks, or any other form.

For example, with reference to FIG. 5, CB1, CB2, CB3 and CB4 are examples of the multiple CBs, wherein CB1 is the first CB and CB2 is the second CB. CB1 is divided (or segmented) into four SBs, i.e., SB11, SB12, SB13 and SB14, which are the components of the first plurality of SBs. CB2 is divided (or segmented) into four SBs, i.e., SB21, SB22, SB23 and SB24, which are the components of the second plurality of SBs. Moreover, CB3 is divided (or segmented) into SB31, SB32, SB33 and SB34, and CB4 is divided (or segmented) into SB41, SB42, SB43 and SB44. The first SB set may be any one of the following:

SB11, SB21, SB31 and SB41; SB12, SB22, SB32 and SB42; SB13, SB23, SB33 and SB43; SB14, SB24, SB34 and SB44.

As an optional implementation, the first SB set is SB11, SB21, SB31 and SB41, then the first SB is SB11 and the second SB is SB21.

The sender may randomly select the first SB from the first plurality of SBs and the second SB from the second plurality of SBs, to generate the first SB set. Alternatively, it may select first SB and the second SB by other methods, such as an interleaving method illustrating in FIG. 6. There are no restrictions on how to generate the first SB set according to the multiple CBs.

After generating the multiple CBs, the sender may perform S830 below.

S830, the sender generates a first mother codeword according to the first SB set, wherein the first mother codeword comprises the first SB set and a first check bit set, the first check bit set is determined based on the first SB set.

The first check bit set may be named as a CCB, and it may be generated by using a FEC method such as LDPC coding method, Polar coding method, or Turbo coding method.

For example, with reference to FIG. 5, the first SB set may be SB11, SB21, SB31 and SB41, by using LDPC coding method to process SB11, SB21, SB31 and SB41, CCB1 may be generated. Then SB11, SB21, SB31, SB41 and CCB1 may be written into a circular buffer as the first mother codeword.

In some cases, the sender may only generate one mother codeword.

For example, with reference to FIG. 5, CB1, CB2, CB3 and CB4 are transmitted in an initial transmission, while only SB11, SB21, SB31 and SB41 are not decoded correctly, then the sender may only generate one mother codeword including SB11, SB21, SB31, SB41 and CCB1.

In some cases, both the first CB and the second CB need to be retransmitted, the sender may generate multiple mother codewords including a second mother codeword and the first mother codeword, to improve the retransmission reliability of the first CB and the second CB.

In an optional implementation, the method 800 further comprises:
generating a second SB set according to the multiple CBs, wherein the second SB set comprises a third SB from the first plurality of SBs and a fourth SB from the second plurality of SBs; generating a second mother codeword according to the second SB set, wherein the second mother codeword comprises the second SB set and a second check bit set, the second check bit set is determined based on the second SB set; outputting a second bit set according to the second mother codeword, wherein the second bit set comprises a first RV of the second mother codeword.

For example, with reference to FIG. 5, CB1, CB2, CB3 and CB4 are transmitted in an initial transmission, while SB11, SB21, SB31, SB41, SB12, SB22, SB32 and SB42 are not decoded correctly, then the sender may generate two mother codewords, wherein one of the two mother codewords includes SB11, SB21, SB31, SB41 and CCB1, another of the two mother codewords includes SB12, SB22, SB32, SB42 and CCB2.

It should be noted that, when the sender generates more than one mother codeword, such as the first mother codeword and the second mother codeword, it may generate them parallel or serially.

After generating the first mother codeword, the sender may perform S840 below.

S840, the sender outputs a first bit set according to the first mother codeword, wherein the first bit set comprises a first RV of the first mother codeword.

The first RV may be any RV, such as RV0, RV1, RV2 or RV3.

In an optional implementation, the first RV starts from a first parity bit of the first mother codeword and includes a highest number of parity bits, or the first RV starts at an extended parity bit of the first mother codeword and most bits of the first RV are parity bits having degree one, or the first RV starts at the ending part of the first mother codeword and most bits of the first RV are systematic bits of the first mother codeword.

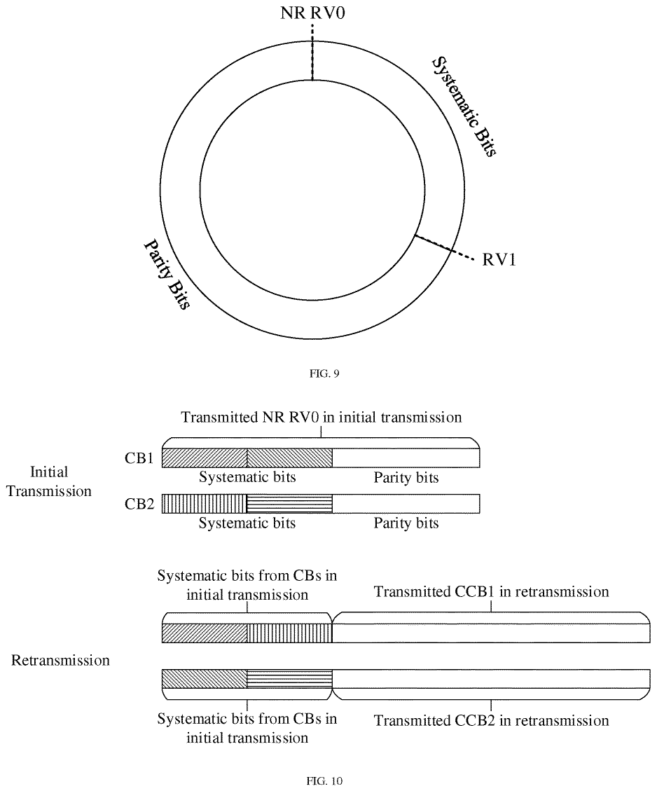

Optionally, we shall refer to the first RV as RV1. In FIG. 9, we demonstrate how the starting position of RV1 is located in the circular buffer, together with NR RV0, which usually is transmitted in initial transmission.

For example, with reference to FIG. 9, in the circular buffer, the starting position of RV1 is calculated by the formula 20 Z for LDPC BG1 or 8 Z for LDPC BG2, where Z refers to the lifting size of NR LDPC code.

The reason to define RV1 starting at the first parity bit of the mother codeword is that systematic/information bits of CBs were already transmitted in initial transmission. Thus, it would be desirable to transmit as much as possible parity bits for these CBs in retransmission. In other words, when the starting positions of CCBs are selected from the mother codewords, one may want the CCBs to have the highest number of parity bits such that, when combining with the systematic/information bits of CBs in initial transmission and the parity bits of CCBs in retransmission, a codeword with a lowest code rate as possible can be generated, providing a better decoding result.

In FIG. 10, we illustrate an example of combining systematic/information bits of CBs in initial transmission and parity bits of CCBs in retransmission. More specifically, in this example, we consider two CBs in initial transmission and two CCBs in retransmission. Supposing the NR RV0 is selected for both CBs and is transmitted in initial transmission and a retransmission is required, the process of generating and transmitting CCBs can be described as follows.

The systematic parts of CBs are first interleaved or vertically segmented to generate two vertical systematic blocks (or referred to as cross systematic blocks). Such two vertical systematic blocks are then encoded by LDPC codes to form two mother codewords. For each mother codeword, RV1 starting at the first parity bits is selected to form the CCBs and transmitted in retransmission.

As shown in FIG. 10, CB1 is an example of the first CB, and CB2 is an example of the second CB.

In the initial transmission, NR RV0 is selected and transmitted for CB1 and CB2, wherein, CB1 includes SB11 and SB12, CB2 includes SB21 and SB22, parity bit set 1 is generated based on SB11 and SB12, parity bit set 2 is generated based on SB21 and SB22.

In the retransmission, systematic bit set 1 includes SB11 and SB21, systematic bit set 2 includes SB12 and SB22, CCB 1 is generated based on SB11 and SB21, CCB 2 is generated based on SB12 and SB22. The combination of systematic bit set 1 and CCB 1 is an example of the first mother codeword, and the combination of systematic bit set 2 and CCB 2 is an example of the second mother codeword. RV1 is selected and transmitted for the first mother codeword and the second mother codeword.

By doing so, RV1 comprises a highest number of parity bits from the mother codewords. At the receiver, the systematic bits of two CBs obtained in initial transmission are interleaved, e.g., vertically segmented, to generate two vertical systematic blocks (or referred to as cross systematic blocks). Such two vertical systematic blocks are then combined with the parity bits from CCBs obtained in retransmission to form two LDPC codewords for decoding. Because RV1 comprises a highest number of parity bits, such two LDPC codewords have lowest possible code rates, thus providing a better coding gain.

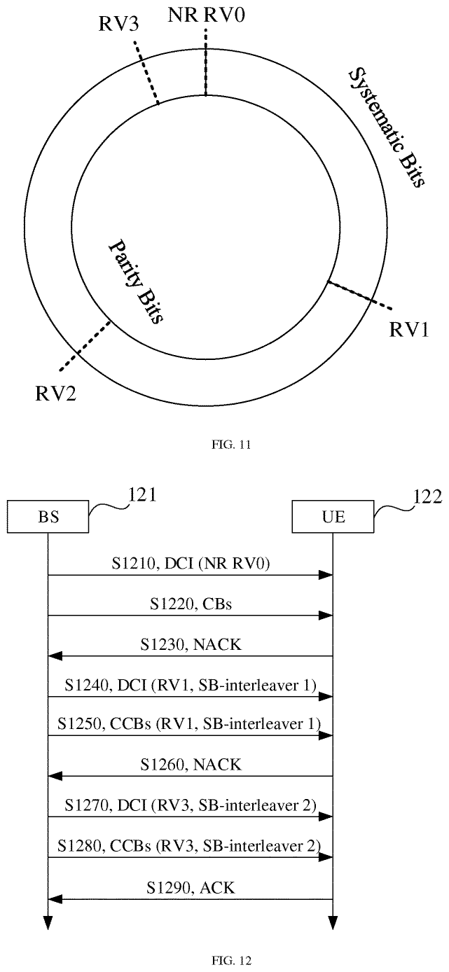

We should note that the transmitter (i.e., the sender) may not be required to select the RV1 defined above to perform cross-CB coding scheme in HARQ retransmission. It follows that a new set of RVs including RV1, RV2 and RV3 can be defined for cross-CB coding. FIG. 11 shows an example of starting points of RV1 and RV2 and RV3 in circular buffer for LDPC BG1. In principle, the starting positions of RV1, RV2 and RV3 are selected such that they are (approximately) located equally in the circular buffer. In NR LDPC code, a codeword before rate matching (referred to as a mother codeword) typically consists of three disjoint portions or parts, i.e., systematic bits, core parity bits and extended parity bits. Further, parity bits comprise both core and extended parity bits.

Generally, RV1 starts from a first parity bit of the mother codeword and includes a highest number of parity bits. RV2 may start at an extended parity bit of a mother codeword and most bits of RV2 may be parity bits having degree one. RV3 may start at the ending part of the mother codeword (i.e., the ending of the circular buffer) and most bits of RV3 may be the systematic/information bits of the mother codeword.

In TABLE 1 below, we provide an example of formulas to calculate the starting positions of RV1, RV2 and RV3 in circular buffer for both LDPC BG1 and LDPC BG2 of NR LDPC code. Note that in TABLE 1, Z refers to the lifting size and N_{ccb} refers to the codelength of CCB, i.e., the number of coded bits after rate-matching. Further, └x┘ refers to the flooring operation of a real number x, i.e., the maximum integer number that is smaller or equal to x.

TABLE 1

| RVi | LDPC BG₁ | LDPC BG₂ |
|---|---|---|
| RV₁ | 20 Z | 8 Z |
| RV₂ | $⌊ \frac{35 {N}_{c c b}}{66 Z} ⌋ Z$ | $⌊ \frac{27 {N}_{c c b}}{50 Z} ⌋ Z$ |
| RV₃ | $⌊ \frac{58 {N}_{c c b}}{66 Z} ⌋ Z$ | $⌊ \frac{47 {N}_{c c b}}{50 Z} ⌋ Z$ |

After outputting the first bit set, the sender may send the first bit set, that is to say, perform S850.

Correspondingly, for the receiver, it receives the first bit set.

The first bit set may be transmitted after processing of physical layer at the sender and be decoded at the receiver. The sender may send the first bit set periodically or aperiodically. Also, the sender may send the first bit set autonomously, or based on a request of the receiver. In any embodiment of this application, there is no restriction for how to send or receive the first bit set.

After receiving the first bit set, the receiver may decode the first bit set according to the first CB and the second CB, that is to say, perform S860.

The first CB and the second CB correspond to the first RV, which can be jointly decoded with other RVs corresponding to the first mother codeword, to obtain a better decoding gain. The receiver may determine the first RV by pre-defined information, wherein the pre-defined information may be information that configured by the manufacturer of the receiver or a network operator. Alternatively, the receiver may determine the first RV by information that received from the sender.

In an optional implementation, the receiver may receive first information, wherein the first information indicates the first RV.

Correspondingly, the sender sends the first information.

The first information may be a DCI or an UCI or any other form, it may be sent before or at the same time as the first bit set. For different retransmissions, RVs may be the same or different. In case of RVs are the same in different retransmissions, the sender may indicate the RVs once or multiple times.

By the first information, the receiver may determine the RV of the current retransmission, and the sender may select different RVs in different retransmissions, so that the flexibility of retransmission in cross-CB coding can be improved.

The receiver may determine the first SB set by pre-defined information, wherein the pre-defined information may be information that configured by the manufacturer of the receiver or a network operator. Alternatively, the receiver may determine the first SB set by information that received from the sender.

In an optional implementation, the receiver may receive second information, wherein the second information indicates the first SB set.

Correspondingly, the sender sends the second information.

The second information may be a DCI or an UCI or any other form, it may be sent before or at the same time as the first bit set, and it may be sent before or after or at the same time as the first information.

By the second information, the receiver may determine the first SB set of the current retransmission, and the sender may select different SB sets in different retransmissions, so that the flexibility of retransmission in cross-CB coding can be improved.

As mentioned above, the sender may generate the first SB set according to the multiple CBs, by a first interleaver. In this case, the second information indicates the first interleaver. For example, the second information is the index of the first interleaver, compared to indicate the IDs of SBs in the first SB set, the amount of information that needs to be transmitted is reduced, so that the transmission resource can be saved.

For different retransmissions, interleavers may be the same or different. In case of interleavers are the same in different retransmissions, the sender may indicate the interleavers once or multiple times.

To summarize, in method 800, the first check bit set may be generated based on the first SB set, by a FEC method such as LDPC, Polar code or Turbo code, and the first mother codeword may be a combination of the first SB set and the first check bit set. The first RV may be a traditional RV (NR RV), or a new RV different from the traditional RV. And the index of the first RV may be indicated by an indication of a sender, or may be pre-defined information. By outputting the first RV of the first mother codeword, the first RV can be jointly decoded with other RVs corresponding to the first mother codeword at a receiver, to obtain a better decoding gain. Thus, the transmission reliability of cross-CB coding can be improved.

In some cases, the first bit set is not decoded correctly at the receiver, so it needs to be retransmitted again.

In an optional implementation, the sender may perform:
generating a third SB set according to the multiple CBs, wherein the third SB set comprises a fifth SB from the first plurality of SBs and a sixth SB from the second plurality of SBs; generating a third mother codeword according to the third SB set, wherein the third mother codeword comprises the third SB set and a third check bit set, the third check bit set is determined based on the third SB set; outputting a third bit set according to the third mother codeword, wherein the third bit set comprises a second RV of the third mother codeword.

In an optional implementation, the second RV starts from a first parity bit of the third mother codeword and includes a highest number of parity bits, or the second RV starts at an extended parity bit of the third mother codeword and most bits of the second RV are parity bits having degree one, or the second RV starts at the ending part of the third mother codeword and most bits of the second RV are systematic bits of the third mother codeword.

The generation process of the third bit set may refer to the generation process of the first bit set; details are not described herein again.

The third bit set and the first bit set belong to different retransmissions, the second RV may be the same as the first RV or different from the first RV, moreover, the third bit set and the first bit set may be different or the same, so that the flexibility of retransmission in cross-CB coding can be improved.

For example, with reference to FIG. 5, both the first SB set and the third SB set are SB11, SB21, SB31 and SB41, both the first SB and the fifth SB are SB11 and both the second SB and the sixth SB are SB21. That is to say, the first mother codeword is the same as the third mother codeword. With reference to FIG. 11, the first RV may be RV1, while the second RV may be RV2 or RV3. Alternatively, both the first RV and the second RV may be RV1. In the former case, the third bit set is different from the first bit set. In the latter case, the third bit set is the same as the first bit set.

For another example, with reference to FIG. 6, the first SB set is SB11, SB21, SB31 and SB41 generated by interleaver1, while the third SB set is SB11, SB22, SB33 and SB44 generated by interleaver2. Wherein, the first SB and the second SB are SB11 and SB21, the fifth SB and the sixth SB are SB11 and SB21. That is to say, the first mother codeword is different from the third mother codeword. With reference to FIG. 11, the first RV may be RV1, while the second RV may be RV2 or RV3. Alternatively, both the first RV and the second RV may be RV1. In any case of this example, the third bit set is different from the first bit set.

Similar to the first bit set, index of RV and interleaver corresponding to the third bit set may be indicated by an indication of the sender, or may be pre-defined information. Details are not described herein again.

When the index of the second RV is the same as the index of the first RV, the index of the second RV may be default information which does not need to be transmitted, so that the transmission resource can be saved.

After outputting the third bit set, the sender may send third information and/or fourth information, wherein the third information indicates the second RV, the fourth information indicates the third SB set.

Correspondingly, the receiver receives the third information and/or the fourth information.

The third information may be a DCI or an UCI or any other form, it may be sent before or at the same time as the third bit set. By the third information, the receiver may determine the RV of the current retransmission, and the sender may select different RVs in different retransmissions, so that the flexibility of retransmission in cross-CB coding can be improved.

The fourth information may be a DCI or an UCI or any other form, it may be sent before or at the same time as the first bit set, and it may be sent before or after or at the same time as the third information. By the fourth information, the receiver may determine the first SB set of the current retransmission, and the sender may select different SB sets in different retransmissions, so that the flexibility of retransmission in cross-CB coding can be improved.

The sender may generate the third SB set according to the multiple CBs, by a second interleaver. In this case, the fourth information indicates the second interleaver. For example, the fourth information is the index of the second interleaver, compared to indicate the IDs of SBs in the third SB set, the amount of information that needs to be transmitted is reduced, so that the transmission resource can be saved.

The above content described a retransmission based on the third mother codeword, optionally, the sender may not generate the third mother codeword, but retransmit based on the first mother codeword.

In an optional implementation, the sender may perform:
outputting a fourth bit set according to the first mother codeword, wherein the fourth bit set comprises a third RV of the first mother codeword.

In the present implementation, the interleaving method of the first CB and the second CB is fixed in different retransmissions, so a sender may not need to generate different mother codewords in different retransmissions, and the IDs of SBs in the first SB set or the index of an interleaver does not need to be transmitted either, so that the computing and transmission resources can be saved.

In an optional implementation, the third RV starts from a first parity bit of the first mother codeword and includes a highest number of parity bits, or the third RV starts at an extended parity bit of the first mother codeword and most bits of the third RV are parity bits having degree one, or the third RV starts at the ending part of the first mother codeword and most bits of the third RV are systematic bits of the first mother codeword.

In other words, the third RV may be the same as the first RV or different from the first RV. Whether the third RV is the same as the first RV or different from the first RV, the sender may send fifth information to indicate the third RV. Correspondingly, the receiver receives the fifth information.

By the fifth information, the receiver may determine the RV of the current retransmission, and the sender may select different RVs in different retransmissions, so that the flexibility of retransmission in cross-CB coding can be improved.

In this application, the method 800 may be applied to a plurality of scenarios. Therefore, implementations of several scenarios are exemplarily listed, and the following separately describes the implementations.

When multiple retransmissions may be required to successfully decode the data, transmitter may have the following options to generate the CCBs in each retransmission.

Option 1: CCBs are flexibly generated from different SB-interleavers and different RVs.

Option 2: CCBs are generated from different SB-interleavers and the same RV.

Option 3: CCBs are generated from the same SB-interleaver and different RVs.

Option 2 and Option 3 are special cases of Option 1. In Option 1, one may indicate both the SB-interleaver index and (LDPC) RV index in the control information (e.g., DCI, UCI or SCI) sent from transmitter to receiver, which increases the signaling overheard. For example, when the cross-CB coding is adopted for HARQ retransmission, two fields, namely “redundancy version” and “subblock-interleaver index” may be defined in the DCI to indicate the RV and SB-interleaver index in each retransmission. Meanwhile, in Option 2 and Option 3, either SB-interleaver index or RV index is fixed, thus only one field in control information may be used to indicate the SB-interleaver for Option 2 or the RV index for Option 3, which reduces the signaling overhead compared to Option 1. For example, the “redundancy version” field in DCI can be used to indicate the SB-interleaver for Option 2 or the RV index for Option 3 in each retransmission.

In FIG. 12, we illustrate an example of transmission process for Option 1 in which different (LDPC) RV and SB-interleaver are indicated separately in each retransmission for DL transmission from BS 121 to UE 122 with two retransmissions. As shown, BS 121 is an example of the sender in method 800, and UE 122 is an example of the receiver in method 800.

S1210, BS 121 sends a DCI to UE 122.

In initial transmission, BS 121 first sends a DCI to UE 122 to inform UE 122 how to receive the DL data. Specifically, DCI may include the information about resources to receive the DL data, modulation and coding scheme (MCS), redundancy version and other control information.

S1220, BS 121 sends CBs to UE 122.

Here, CBs with NR RV0 (an example of the multiple CBs) are transmitted in initial transmission. UE 122 will decode DL data (i.e., the CBs) after receiving the CBs.

S1230, UE 122 sends NACK to BS 121.

After decoding the DL data unsuccessfully, UE 122 feeds back NACK (an example of the sixth information) to BS 121 to inform the decoding result.

S1240, BS 121 sends DCI to UE 122.

BS 121 sends a DCI to UE 122 to tell UE 122 how to receive the retransmission. In such DCI, RV1 and SB-interleaver 1 are indicated separately in, for example, “redundancy version (an example of the first information)” and “subblock-interleaver index (an example of the second information)” fields, respectively. After sending the DCI, BS 121 generates CCBs (an example of the first bit set) using SB-interleaver 1 and LDPC RV1.

S1250, BS 121 sends CCBs to UE 122.

Here, CCBs with RV1 are transmitted in the first retransmission. After receiving the CCBs, UE 122 combines the CBs in the initial transmission and CCBs in the retransmission to jointly decode the DL data. Assuming that UE 122 cannot decode successfully the data and feeds back another NACK to BS 121, then UE 122 may perform S1260 below.

S1260, UE122 sends NACK to BS 121.

S1270, BS 121 sends DCI to UE 122.

After receiving the NACK in S1260, BS 121 may send another DCI (an example of the third information and the fourth information) for 2nd retransmission, indicating that RV3 and SB-interleaver 2 will be used. BS 121 then generates another set of CCBs (an example of the third bit set) based on SB-interleaver 2 and RV3 and performs S1280 below.

S1280, BS 121 sends CCBs to UE 122.

Here, CCBs with RV3 are transmitted in the second retransmission. After receiving the CCBs in S1280, UE 122 combines the CBs from the initial transmission and the CCBs from the two retransmissions for joint decoding data. UE 122 now can successfully decode the DL data and feeds back ACK to BS 121. Then UE 122 may perform S1290 below.

S1290, UE 122 sends ACK to BS 121.

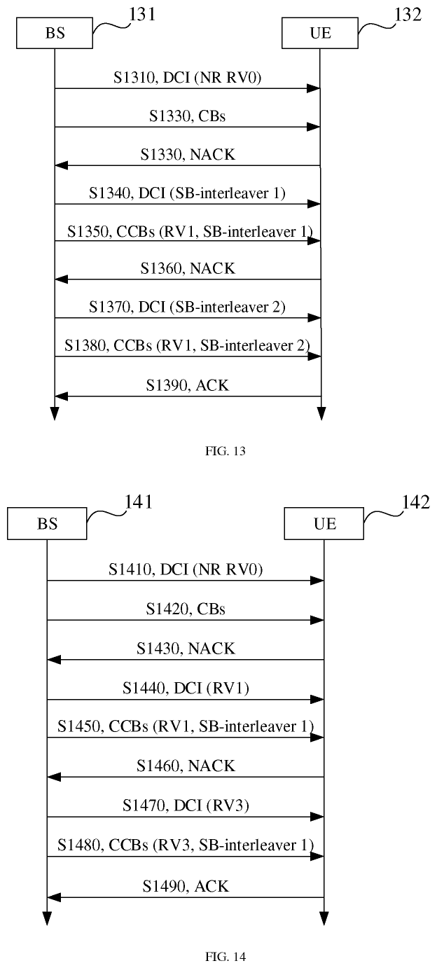

FIG. 13 illustrates an example of transmission process for Option 2 in which different SB-interleaver and the same RV are selected in each retransmission. As shown, BS 131 is an example of the sender in method 800, and UE 132 is an example of the receiver in method 800. In FIG. 13, NR RV0 (an example of the multiple CBs) is also transmitted in initial transmission and UE 132 also feeds back NACK (an example of the sixth information) to BS 131 to inform BS 131 about the unsuccessful decoding result. BS 131 then transmits two DCIs to UE 132, using the “subblock-interleaver index” field (an example of the second information or the fourth information) in the DCIs to indicate that SB-interleaver 1 and SB-interleaver 2 will be used in 1st and 2nd retransmissions, respectively. Further, RV1 is fixed in all retransmissions, meaning that the procedure of generating RV1 may be defined in standard and commonly known by both BS 131 and UE 132. Details are described below.

S1310, BS 131 sends a DCI to UE 132.

In initial transmission, BS 131 first sends a DCI to UE 132 to inform UE 132 how to receive the DL data. Specifically, DCI may include the information about resources to receive the DL data, MCS, redundancy version and other control information.

S1320, BS 131 sends CBs to UE 132.

Here, CBs with NR RV0 (an example of the multiple CBs) are transmitted in initial transmission. UE 132 will decode DL data (i.e., the CBs) after receiving the CBs.

S1330, UE 132 sends NACK to BS 131.

After decoding the DL data unsuccessfully, UE 132 feeds back NACK (an example of the sixth information) to BS 131 to inform the decoding result.

S1340, BS 131 sends DCI to UE 132.

BS 131 sends a DCI to UE 132 to tell UE 132 how to receive the retransmission. In such DCI, SB-interleaver 1 is indicated in, for example, “subblock-interleaver index (an example of the second information)” fields. After sending the DCI, BS 131 generates CCBs (an example of the first bit set) using SB-interleaver 1 and LDPC RV1.

S1350, BS 131 sends CCBs to UE 132.

Here, CCBs with RV1 are transmitted in the first retransmission. After receiving the CCBs, UE 132 combines the CBs in the initial transmission and CCBs in the retransmission to jointly decode the DL data. Assuming that UE 132 cannot decode successfully the data and feeds back another NACK to BS 131, then UE 132 may perform S1360 below.

S1360, UE132 sends NACK to BS 131.

S1370, BS 131 sends DCI to UE 132.

After receiving the NACK in S1360, BS 131 may send another DCI (an example of the third information and the fourth information) for 2nd retransmission, indicating that SB-interleaver 2 will be used. BS 131 then generates another set of CCBs (an example of the third bit set) based on SB-interleaver 2 and RV1 and performs S1380 below.

S1380, BS 131 sends CCBs to UE 132.

Here, CCBs with RV1 are transmitted in the second retransmission. After receiving the CCBs in S1380, UE 132 combines the CBs from the initial transmission and the CCBs from the two retransmissions for joint decoding data. UE 132 now can successfully decode the DL data and feeds back ACK to BS 131. Then UE 132 may perform S1390 below.

S1390, UE 132 sends ACK to BS 131.

In FIG. 14, we illustrate an example of transmission process for Option 3 in which the same SB-interleaver and different RV are used in each retransmission. As shown, BS 141 is an example of the sender in method 800, and UE 142 is an example of the receiver in method 800. Similar to examples in FIG. 12 and FIG. 13, NR RV0 (an example of the multiple CBs) is also transmitted in initial transmission. To perform retransmissions, BS 141 first sends one or more DCIs to UE 142 to tell UE 142 how to receive the retransmission data. In the DCIs, “redundancy version” field (an example of the first information or the third information) may be used to indicate that RV1 and RV3 will be used in 1st and 2nd retransmission, respectively. In this example, SB-interleaver 1 is fixed for all retransmissions, i.e., the procedure of performing SB-interleaver may be defined in standard and are commonly known by both BS 141 and UE 142. Details are described below.

S1410, BS 141 sends a DCI to UE 142.

In initial transmission, BS 141 first sends a DCI to UE 142 to inform UE 142 how to receive the DL data. Specifically, DCI may include the information about resources to receive the DL data, MCS, redundancy version and other control information.

S1420, BS 141 sends CBs to UE 142.

Here, CBs with NR RV0 (an example of the multiple CBs) are transmitted in initial transmission. UE 142 will decode DL data (i.e., the CBs) after receiving the CBs.

S1430, UE 142 sends NACK to BS 141.

After decoding the DL data unsuccessfully, UE 142 feeds back NACK (an example of the sixth information) to BS 141 to inform the decoding result.

S1440, BS 141 sends DCI to UE 142.

BS 141 sends a DCI to UE 142 to tell UE 142 how to receive the retransmission. In such DCI, RV1 is indicated in, for example, “redundancy version (an example of the first information)” fields. After sending the DCI, BS 141 generates CCBs (an example of the first bit set) using SB-interleaver 1 and LDPC RV1.

S1450, BS 141 sends CCBs to UE 142.

Here, CCBs with RV1 are transmitted in the first retransmission. After receiving the CCBs, UE 142 combines the CBs in the initial transmission and CCBs in the retransmission to jointly decode the DL data. Assuming that UE 142 cannot decode successfully the data and feeds back another NACK to BS 141, then UE 142 may perform S1460 below.

S1460, UE142 sends NACK to BS 141.

S1470, BS 141 sends DCI to UE 142.

After receiving the NACK in S146o, BS 141 may send another DCI (an example of the third information and the fourth information) for 2nd retransmission, indicating that RV3 will be used. BS 141 then generates another set of CCBs (an example of the third bit set) based on SB-interleaver 2 and RV3 and performs S1480 below.

S1480, BS 141 sends CCBs to UE 142.

Here, CCBs with RV3 are transmitted in the second retransmission. After receiving the CCBs in S1480, UE 142 combines the CBs from the initial transmission and the CCBs from the two retransmissions for joint decoding data. UE 142 now can successfully decode the DL data and feeds back ACK to BS 141. Then UE 142 may perform S1490 below.

S1490, UE 142 sends ACK to BS 141.

We should note that, RV1 and RV3 may be defined in FIG. 11 and TABLE 1 via the circular buffer. However, the retransmission may not be limited to a fixed RV index or a fixed SB-interleaver index. Therefore, any RV and any SB-interleaver index may be selected by BS in each retransmission. Further, the CCB retransmission may not be limited to the DL and can be implemented in uplink (UL) and sidelink (SL).

In examples illustrated in FIGS. 12, 13 and 14, cross-CB coding may be chosen as a single HARQ scheme in standard. It follows that, the set of RVs used to generate the CCBs in each retransmission may be defined as in FIG. 11 and TABLE 1.

In another example, cross-CB coding and another HARQ scheme, e.g., traditional HARQ IR in 5G NR, may coexist as two options for HARQ schemes. It follows that cross-CB coding may be explicitly indicated by BS, for example, in RRC signaling as the chosen HARQ scheme. For example, one may define the “harqOption” field having two states in RRC signaling to specify which HARQ scheme to be used in retransmission, for example, if harqOption=harqType0, traditional HARQ IR is selected. Otherwise, if harqOption=harqType1, cross-CB coding is selected.

In another example, cross-CB coding scheme can be indicated implicitly through, e.g., transmission scenario. For example, if pre-emption by URLLC happens in eMBB data and retransmission of eMBB is required, BS can automatically select cross-CB coding for retransmission. Upon receiving the pre-emption indication from BS, UE may understand the cross-CB coding shall be used in retransmission.

If both cross-CB coding and traditional HARQ IR coexist as two options for HARQ scheme, each scheme may use a different set of RVs. For example, traditional HARQ IR may use the NR RV set defined 5G NR standard, while cross-CB coding may use the RV set defined in FIG. 11 and TABLE 1.

Alternatively, in some examples, if one may adopt only one RV set for both cross-CB coding and traditional HARQ IR, RV1 defined in FIG. 11 and TABLE 1 for cross-CB coding may replace NR RV1 in 5G NR because the difference in starting positions of RV1 and NR RV1 in circular buffer is small, i.e., approximately 2Z with Z being the lifting size. The new RV set now comprises NR RV0, RV1, NR RV2 and NR RV3.

Alternatively, in some examples, NR RV set including NR RV0, NR RV1, NR RV2, and NR RV3 in 5G NR may be used for cross-CB coding. For example, NR RV2 may be transmitted in a retransmission when cross-CB coding is employed. Similarly, NR RV1, NR RV3 or NR RV0 may also be transmitted in a retransmission when cross-CB coding is employed.

The examples of methods provided in the embodiments of this application are described in detail in the above, and it is understood that the corresponding devices, in order to achieve the above functions, contain the corresponding hardware structures and/or software modules to implement each function. It should be readily apparent to those skilled in the art that, in combination with the units and algorithmic steps of the examples described in the embodiments disclosed herein, this application may be implemented in hardware or in a combination of hardware and computer software. Whether a function is performed in hardware or computer software drives hardware depends on the specific application and design constraints of the technical solution. Technical professionals may use different methods for each particular application to achieve the described functionality, but such implementation should not be considered beyond the scope of this application.

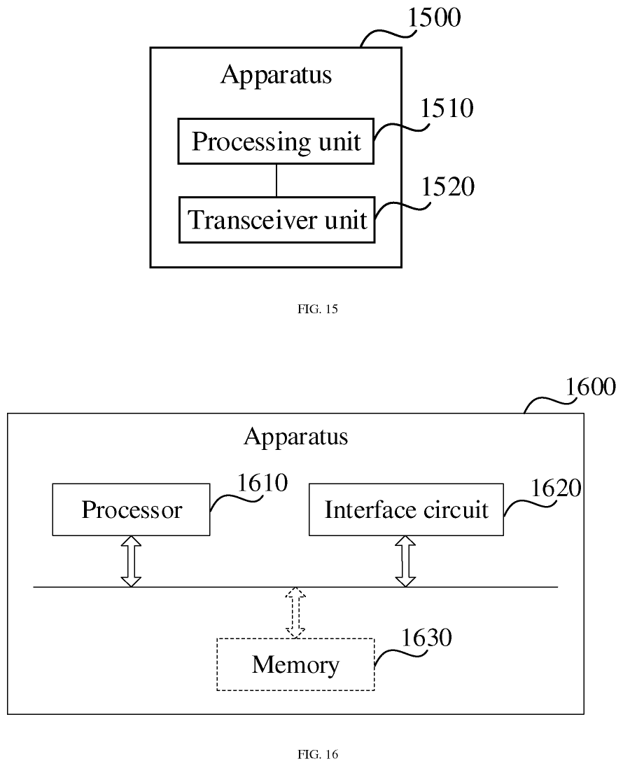

FIG. 15 and FIG. 16 are two schematic diagrams of structure of communication apparatus provided by the embodiments of this application, which may be used to implement the functions of the terminal or BS in the embodiments of the above method, and therefore also have the beneficial effects of the embodiments of the above method. In embodiments of this application, these apparatuses may be terminals or BSs as shown in FIG. 1, or modules (e.g., chips) applied to terminals or BSs.

As shown in FIG. 15, apparatus 1500 comprises a processing unit 1510 and a transceiver unit 1520. The transceiver unit 1520 performs the receiving step and/or the sending step under the control of the processing unit 1510, where the transceiver unit 1520 is a sending unit when a sending step is performed, and the transceiver unit 1520 is a receiving unit when a receiving step is performed. The apparatus 1500 is used to implement the functions of the terminal or BS in the method embodiment described in the above.

While the apparatus 1500 is used to implement the function of the sender in the embodiment of the method described in FIG. 8, the processing unit 1510 is configured to perform: obtaining multiple CBs, wherein the multiple CBs comprise a first CB and a second CB, the first CB comprises a first plurality of subblocks (SBs), and the second CB comprises a second plurality of SBs; generating a first SB set according to the multiple CBs, wherein the first SB set comprises a first SB from the first plurality of SBs and a second SB from the second plurality of SBs; generating a first mother codeword according to the first SB set, wherein the first mother codeword comprises the first SB set and a first check bit set, the first check bit set is determined based on the first SB set; outputting a first bit set according to the first mother codeword, wherein the first bit set comprises a first RV of the first mother codeword.

Optionally, the transceiver unit 1520 is configured to perform: sending first information, wherein the first information indicates the first RV.

Optionally, the first RV starts from a first parity bit of the first mother codeword and includes a highest number of parity bits, or the first RV starts at an extended parity bit of the first mother codeword and most bits of the first RV are parity bits having degree one, or the first RV starts at the ending part of the first mother codeword and most bits of the first RV are systematic bits of the first mother codeword.

Optionally, the transceiver unit 1520 is further configured to perform: sending second information, wherein the second information indicates the first SB set.

Optionally, the processing unit 1510 is further configured to perform: generating the first SB set according to the multiple CBs, by a first interleaver; wherein the second information indicates the first SB set, comprises: the second information indicates the first interleaver.

Optionally, the processing unit 1510 is further configured to perform: generating a second SB set according to the multiple CBs, wherein the second SB set comprises a third SB from the first plurality of SBs and a fourth SB from the second plurality of SBs; generating a second mother codeword according to the second SB set, wherein the second mother codeword comprises the second SB set and a second check bit set, the second check bit set is determined based on the second SB set; outputting a second bit set according to the second mother codeword, wherein the second bit set comprises a first RV of the second mother codeword.

Optionally, the transceiver unit 1520 is further configured to perform: sending the first bit set.

Optionally, the processing unit 1510 is further configured to perform: generating a third SB set according to the multiple CBs, wherein the third SB set comprises a fifth SB from the first plurality of SBs and a sixth SB from the second plurality of SBs; generating a third mother codeword according to the third SB set, wherein the third mother codeword comprises the third SB set and a third check bit set, the third check bit set is determined based on the third SB set; outputting a third bit set according to the third mother codeword, wherein the third bit set comprises a second RV of the third mother codeword.

Optionally, the transceiver unit 1520 is further configured to perform: sending third information, wherein the third information indicates the second RV.

Optionally, the second RV starts from a first parity bit of the third mother codeword and includes a highest number of parity bits, or the second RV starts at an extended parity bit of the third mother codeword and most bits of the second RV are parity bits having degree one, or the second RV starts at the ending part of the third mother codeword and most bits of the second RV are systematic bits of the third mother codeword.

Optionally, the index of the second RV is the same as the index of the first RV.

Optionally, the transceiver unit 1520 is further configured to perform: sending fourth information, wherein the fourth information indicates the third SB set.

Optionally, the processing unit 1510 is further configured to perform: generating the third SB set according to the multiple CBs, by a second interleaver; wherein the fourth information indicates the third SB set, comprises: the fourth information indicates the second interleaver.

Optionally, the processing unit 1510 is further configured to perform: outputting a fourth bit set according to the first mother codeword, wherein the fourth bit set comprises a third RV of the first mother codeword.

Optionally, the transceiver unit 1520 is further configured to perform: sending fifth information, wherein the fifth information indicates the third RV.

Optionally, the third RV starts from a first parity bit of the first mother codeword and includes a highest number of parity bits, or the third RV starts at an extended parity bit of the first mother codeword and most bits of the third RV are parity bits having degree one, or the third RV starts at the ending part of the first mother codeword and most bits of the third RV are systematic bits of the first mother codeword.

Optionally, the transceiver unit 1520 is further configured to perform: receiving sixth information, the sixth information indicates retransmitting the multiple CBs; wherein the processing unit 1510 is further configured to perform: obtaining the multiple CBs, according to the sixth information.

While the apparatus 1500 is used to implement the function of the receiver in the embodiment of the method described in FIG. 8, the transceiver unit 1520 is configured to perform: receiving a first bit set, wherein the first bit set comprises a first RV of a first mother codeword, the first mother codeword comprises a first SB set and a first check bit set, the first SB set comprises a first SB from a first plurality of SBs and a second SB from a second plurality of SBs, the first plurality of SBs belongs to a first CB, the second plurality of SBs belongs to a second CB, the first check bit set is determined based on the first SB set; the processing unit 1510 is configured to perform: decoding the first bit set according to the first CB and the second CB.

Optionally, the transceiver unit 1520 is further configured to perform: receiving first information, wherein the first information indicates the first RV; the processing unit 1510 is further configured to perform: decoding the first bit set according to the first CB, the second CB and the first information.

Optionally, the first RV starts from a first parity bit of the first mother codeword and includes a highest number of parity bits, or the first RV starts at an extended parity bit of the first mother codeword and most bits of the first RV are parity bits having degree one, or the first RV starts at the ending part of the first mother codeword and most bits of the first RV are systematic bits of the first mother codeword.

Optionally, the transceiver unit 1520 is further configured to perform: receiving second information, wherein the second information indicates the first SB set; the processing unit 1510 is further configured to perform: decoding the first bit set according to the first CB, the second CB and the second information.

Optionally, the first SB set is determined by a first interleaver; the second information indicates the first SB set, comprises: the second information indicates the first interleaver.

Optionally, the transceiver unit 1520 is further configured to perform: receiving a second bit set, wherein the second bit set comprises a first RV of a second mother codeword, the second mother codeword comprises a second SB set and a second check bit set, the second SB set comprises a third SB from the first plurality of SBs and a fourth SB from the second plurality of SBs, the second check bit set is determined based on the second SB set; the processing unit 1510 is further configured to perform: decoding the second bit set according to the first CB and the second CB.

Optionally, the transceiver unit 1520 is further configured to perform: receiving a third bit set, wherein the third bit set comprises a second RV of a third mother codeword, the third mother codeword comprises a third SB set and a third check bit set, the third SB set comprises a fifth SB from the first plurality of SBs and a sixth SB from the second plurality of SBs, the third check bit set is determined based on the third SB set; the processing unit 1510 is further configured to perform: decoding the third bit set according to the first CB, the second CB and the first bit set.

Optionally, the transceiver unit 1520 is further configured to perform: receiving third information, wherein the third information indicates the second RV; the processing unit 1510 is further configured to perform: decoding the third bit set according to the first CB, the second CB, the first bit set, and the third information.

Optionally, the second RV starts from a first parity bit of the third mother codeword and includes a highest number of parity bits, or the second RV starts at an extended parity bit of the third mother codeword and most bits of the second RV are parity bits having degree one, or the second RV starts at the ending part of the third mother codeword and most bits of the second RV are systematic bits of the third mother codeword.

Optionally, the index of the second RV is the same as the index of the first RV.

Optionally, the transceiver unit 1520 is further configured to perform: receiving fourth information, wherein the fourth information indicates the third SB set.

Optionally, the third SB set is determined by a second interleaver; the fourth information indicates the third SB set, comprises: the fourth information indicates the second interleaver.

Optionally, the transceiver unit 1520 is further configured to perform: receiving a fourth bit set, wherein the fourth bit set comprises a third RV of the first mother codeword; the processing unit 1510 is further configured to perform: decoding the fourth bit set according to the first CB, the second CB and the first bit set.

Optionally, the transceiver unit 1520 is further configured to perform: receiving fifth information, wherein the fifth information indicates the third RV; the processing unit 1510 is further configured to perform: decoding the fourth bit set according to the first CB, the second CB, the first bit set, and the fifth information.

Optionally, the third RV starts from a first parity bit of the first mother codeword and includes a highest number of parity bits, or the third RV starts at an extended parity bit of the first mother codeword and most bits of the third RV are parity bits having degree one, or the third RV starts at the ending part of the first mother codeword and most bits of the third RV are systematic bits of the first mother codeword.

Optionally, before the receiving a first bit set, the transceiver unit 1520 is further configured to perform: sending sixth information, the sixth information indicates retransmitting the first CB and the second CB.

Optionally, before the receiving a first bit set, the transceiver unit 1520 is further configured to perform: receiving multiple CBs, wherein the multiple CBs comprise the first CB and the second CB.

The apparatus 1500 may be a terminal or a BS. The processing unit 1510 may be implemented by hardware or by software. When the processing unit 1510 is implemented by hardware, the processing unit 1510 is a logic circuit, an integrated circuit, etc. When the processing unit 1510 is implemented by software, the processing unit 1510 may be a general-purpose processor, implemented by reading software code stored in a memory unit, which may be integrated in the processing unit 1510 or may be located outside the processing unit 1510 and exist independently.

As shown in FIG. 16, apparatus 1600 includes a processor 1610 and an interface circuit 1620. The processor 1610 and the interface circuit 1620 are coupled to each other. It is understood that the interface circuit 1620 may be either a transceiver or an input-output interface. Optionally, the apparatus 1600 may also include a memory 1630 to store the instructions executed by the processor 1610, or to store the input data required by the processor 1610 to run the instructions, or to store the data produced after the processor 1610 has run the instructions.

When the apparatus 1600 is used to implement the method shown in FIG. 8 or any other method described in the above, the processor 1610 is used to implement the functions of the above processing unit 1510 and the interface circuit 1620 is used to implement the functions of the above transceiver unit 1520.

When the apparatus 1600 is a terminal chip (that is, a chip applied to a terminal), the terminal chip implements the functions of the terminal in an embodiment of the above method. The terminal chip receives information from the BS, which can be understood as the information is first received by other modules in the terminal (such as radio frequency module or antenna), and then sent to the terminal chip by these modules. The terminal chip sends information to the BS, which can be understood as the information is first sent to other modules in the terminal (such as radio frequency module or antenna), and then sent to the BS by these modules.

When the apparatus 1600 is a BS chip (i.e., a chip applied to a BS), the BS chip implements the functions of the BS in an embodiment of the above method. The BS chip receives information from the terminal, which can be understood as the information is first received by other modules in the BS (such as the radio frequency module or antenna), and then sent to the BS chip by these modules. The BS chip sends information to the terminal, which can be understood as the information is sent to other modules in the BS (such as radio frequency module or antenna), and then sent to the terminal by these modules.

In this application, entity A sends information to entity B, could be from A to B directly or from A to B through other entities. Similarly, entity B receives information from entity A, could be from B to A directly or from B to A through other entities. Here entities A and B may be RAN nodes or terminals, or modules inside the RAN nodes or terminals. The sending and receiving of information may be the information interaction between RAN nodes and terminals, for example, the information interaction between BSs and terminals. The sending and receiving of information can also be the information interaction between two RAN nodes, such as the information interaction between CU and DU. The sending and receiving of information can also be the information interaction between different modules in a device, for example, the information interaction between a terminal chip and other modules in the terminal, or the information interaction between a BS chip and other modules in the BS.

It is understood that the processor in the embodiments of the present application may be a central processor unit (CPU), other general-purpose processors, digital signal processors (DSP), ASIC, FPGA, or any other programmable logic device, transistor logic device, hardware component or any combination thereof. A general-purpose processor may be a microprocessor or any conventional processor.

The method steps in embodiments of the present application may be implemented in hardware or in software instructions that can be executed by a processor.

The above embodiments may be implemented in whole or in part by instructions, software, hardware, firmware, or any combination thereof.

When implemented by instructions, the instructions may be composed of corresponding software modules, the software modules may be stored in a computer readable storage medium. The computer readable storage medium may be a volatile or non-volatile storage medium, or may include both types of volatile and non-volatile storage media. The non-volatile storage medium may be a flash memory, hard disk, mobile hard disk, read-only memory (ROM), programmable ROM (PROM), erasable PROM (EPROM), electrically EPROM (EEPROM), compact disc ROM (CD-ROM), or any other form of non-volatile storage medium well known in the art. The volatile storage medium may be a random access memory (RAM), by illustrative but not restrictive, many forms of RAM are available, such as, registers, static RAM (SRAM), dynamic RAM (DRAM), synchronous DRAM (SDRAM), double data rate SDRAM (DDR SDRAM), enhanced SDRAM (ESDRAM), or any other form of volatile storage medium well known in the art.

An exemplary storage medium is coupled to a processor so that the processor can read information from the storage medium and can write information to the storage medium. The storage medium can also be an integral part of the processor. The processor and the storage medium can be located in an ASIC. Alternatively, the ASIC can be located in a BS or terminal. Processors and storage media can also exist as discrete components in the BS or terminal.

When implemented by software, it can be implemented in whole or in part in the form of a computer program product. The computer program product includes one or more computer programs or instructions. When the computer programs or instructions are loaded and executed on a computer, the process or function described in the embodiment of this application is executed in whole or in part. The computer may be a general computer, a specific computer, a computer network, a network device, an UE or other programmable device. The computer programs or instructions may be stored in or transmitted from one computer readable storage medium to another, for example, the computer programs or instructions may be transmitted from one web site, computer, server or data center to another web site, computer, server or data center by wired or wireless means. The computer readable storage medium may be any available media that the computer can access or a data storage device such as a server or a data center that integrates one or more available media. The available medium may be a magnetic medium, for example, a floppy disk, hard disk, magnetic tape; it can also be an optical medium, for example, a digital video disc; it can also be a semiconductor medium, for example, a solid state disk.

Finally, regarding the embodiments of this application, there are a few more declarations:
First, in the embodiments of this application, the first, second and various numerical numbers are only for the purpose of describing convenient distinctions and are not used to limit the scope of the embodiments of this application. For example, the first information and the third information represent two information, which may be two different information or the same information.
Second, in the embodiments of this application, “indicate” may include direct indicate and indirect indicate, as well as explicit indicate and implicit indicate. The information indicated by a certain information is called the information to be indicated. In the concrete implementation process, there are many ways to indicate the information to be indicated. For example, the information to be indicated can be directly indicated, such as the information to be indicated itself or the index of the information to be indicated. It can also indirectly indicate the information to be indicated by indicating other information, where there is an association relationship between this other information and the information to be indicated. It is also possible to indicate only part of the information to be indicated, and the other parts of the information to be indicated are known or agreed in advance. For example, the indication of the information to be indicated can be realized by pre-agreement (such as protocol stipulation) whether there is an information element, so as to reduce the indication overhead to a certain extent.
Third, the “protocol” refers to in the embodiments of this application may be a standard protocol in the field of communication, for example, it may include long term evolution (LTE) protocol, new radio (NR) protocol and related protocols in future communication systems, and this application is not limited to this.
Fourth, “pre-definition” or “pre-configuration” may be achieved by pre-storing the corresponding code, form or other means indicating relevant information in a device (for example, terminal or BS), and this application does not restrict the specific implementation method. “Store” may mean saved in one or more memories, which may be a separate setting or integrated in the processor or communication device. The one or more memories may also be partially set up separately and partially integrated in the processor or communication device. The type of memories may be any form of storage medium, and this application is not limited to this.
Fifth, “at least one” means one or more, and “multiple” means two or more. “And/or” refers to the association relationship of associated objects, indicating that there can be three relationships, for example, A and/or B, which can represent the situation that A exists alone, B exists alone, and A and B exist simultaneously, where A and B can be a single object or multiple objects. The character “/” generally indicates that the associated object is an “or” relationship. “At least one of the following items (items)” or a similar expression means any combination of these items, including any combination of single or complex items (items). For example, at least one term (s) of a, b, and c can be expressed as a, or, b, or, c, or, a and b, or, a and c, or, b and c, or, a, b, and c. Where a, b, and c can be a single object or multiple objects, respectively.
Sixth, in the embodiments of this application, “when . . . ”, “at the time of . . . ”, “in the case of . . . ”, and “if” all refer to an objective circumstance in which a device (for example, terminal or BS) will make the corresponding processing. They do not limit the time, nor do they require the device to have a judgment action in the implementation, nor do they imply other restrictions.
Seventh, in each embodiment of the application, if there are no special instructions and logical conflicts, the terms and/or descriptions between different embodiments are consistent and can be referred to each other, and the technical features in different embodiments can be combined to form a new embodiment according to their internal logical relationships. The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. In view of the foregoing description it will be evident to a person skilled in the art that various modifications may be made within the scope of the invention.
Eighth, although this disclosure refers to illustrative embodiments, this is not intended to be construed in a limiting sense. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although embodiments and potential advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

What is claimed is:

1. A method comprising:
obtaining multiple code blocks (CBs), wherein the multiple CBs comprise a first CB and a second CB, the first CB comprises a first plurality of subblocks (SBs), and the second CB comprises a second plurality of SBs;
generating a first SB set according to the multiple CBs, wherein the first SB set comprises a first SB from the first plurality of SBs and a second SB from the second plurality of SBs;
generating a first mother codeword according to the first SB set, wherein the first mother codeword comprises the first SB set and a first check bit set, the first check bit set is determined based on the first SB set; and
outputting a first bit set according to the first mother codeword, wherein the first bit set comprises a first redundancy version (RV) of the first mother codeword.

2. The method of claim 1, further comprising:
sending first information, wherein the first information indicates the first RV.

3. The method of claim 1,
wherein the first RV starts from a first parity bit of the first mother codeword and includes a highest number of parity bits; or
the first RV starts at an extended parity bit of the first mother codeword, and more than half of bits of the first RV are parity bits having degree one; or
the first RV starts at an ending part of the first mother codeword, and more than half of bits of the first RV are systematic bits of the first mother codeword.

4. The method of claim 1, further comprising:
sending second information, wherein the second information indicates the first SB set.

5. The method of claim 4, wherein the generating the first SB set according to the multiple CBs comprises:
generating the first SB set according to the multiple CBs by a first interleaver, and
wherein the second information indicates the first SB set by indicating the first interleaver.

6. A method comprising:
receiving a first bit set, wherein the first bit set comprises a first redundancy version (RV) of a first mother codeword, the first mother codeword comprises a first subblock (SB) set and a first check bit set, the first SB set comprises a first SB from a first plurality of SBs and a second SB from a second plurality of SBs, the first plurality of SBs belongs to a first code block (CB), the second plurality of SBs belongs to a second CB, and the first check bit set is determined based on the first SB set; and
decoding the first bit set according to the first CB and the second CB.

7. The method of claim 6, further comprising:
receiving first information, wherein the first information indicates the first RV,
wherein the decoding the first bit set according to the first CB and the second CB comprises:
decoding the first bit set according to the first CB, the second CB, and the first information.

8. The method of claim 6,
wherein the first RV starts from a first parity bit of the first mother codeword and includes a highest number of parity bits; or
the first RV starts at an extended parity bit of the first mother codeword, and more than half of bits of the first RV are parity bits having degree one; or
the first RV starts at an ending part of the first mother codeword, and more than half of bits of the first RV are systematic bits of the first mother codeword.

9. The method of claim 6, further comprising:
receiving second information, wherein the second information indicates the first SB set, and
wherein the decoding the first bit set according to the first CB and the second CB comprises:
decoding the first bit set according to the first CB, the second CB, and the second information.

10. The method of claim 9, wherein the first SB set is determined by a first interleaver, and the second information indicates the first SB set by indicating the first interleaver.

11. An apparatus comprising:
at least one processor; and
memory coupled to the at least one processor and storing instructions that, when executed by the at least one processor, cause the apparatus to perform operations including:
obtaining multiple code blocks (CBs), wherein the multiple CBs comprise a first CB and a second CB, the first CB comprises a first plurality of subblocks (SBs), and the second CB comprises a second plurality of SBs;
generating a first SB set according to the multiple CBs, wherein the first SB set comprises a first SB from the first plurality of SBs and a second SB from the second plurality of SBs;
generating a first mother codeword according to the first SB set, wherein the first mother codeword comprises the first SB set and a first check bit set, the first check bit set is determined based on the first SB set; and
outputting a first bit set according to the first mother codeword, wherein the first bit set comprises a first redundancy version (RV) of the first mother codeword.

12. The apparatus of claim 11, the operations further comprising:
sending first information, wherein the first information indicates the first RV.

13. The apparatus of claim 11,
wherein the first RV starts from a first parity bit of the first mother codeword and includes a highest number of parity bits; or
the first RV starts at an extended parity bit of the first mother codeword, and more than half of bits of the first RV are parity bits having degree one; or
the first RV starts at an ending part of the first mother codeword, and more than half of bits of the first RV are systematic bits of the first mother codeword.

14. The apparatus of claim 11, the operations further comprising:
sending second information, wherein the second information indicates the first SB set.

15. The apparatus of claim 14, wherein the generating the first SB set according to the multiple CBs comprises:
generating the first SB set according to the multiple CBs, by a first interleaver, and
wherein the second information indicates the first SB set by indicating the first interleaver.

16. An apparatus comprising:
at least one processor; and
memory coupled to the at least one processor and storing instructions that, when executed by the at least one processor, cause the apparatus to perform operations including:
receiving a first bit set, wherein the first bit set comprises a first redundancy version (RV) of a first mother codeword, the first mother codeword comprises a first subblock (SB) set and a first check bit set, the first SB set comprises a first SB from a first plurality of SBs and a second SB from a second plurality of SBs, the first plurality of SBs belongs to a first code block (CB), the second plurality of SBs belongs to a second CB, and the first check bit set is determined based on the first SB set; and
decoding the first bit set according to the first CB and the second CB.

17. The apparatus of claim 16, wherein the instructions further cause the apparatus to perform:
receiving first information, wherein the first information indicates the first RV,
wherein the decoding the first bit set according to the first CB and the second CB comprises:
decoding the first bit set according to the first CB, the second CB, and the first information.

18. The apparatus of claim 16,
wherein the first RV starts from a first parity bit of the first mother codeword and includes a highest number of parity bits; or
the first RV starts at an extended parity bit of the first mother codeword, and more than half of bits of the first RV are parity bits having degree one; or
the first RV starts at an ending part of the first mother codeword, and more than half of bits of the first RV are systematic bits of the first mother codeword.

19. The apparatus of claim 16, the operations further comprising:
receiving second information, wherein the second information indicates the first SB set, and
wherein the decoding the first bit set according to the first CB and the second CB comprises:
decoding the first bit set according to the first CB, the second CB, and the second information.

20. The apparatus of claim 19, wherein the first SB set is determined by a first interleaver, and the second information indicates the first SB set by indicating the first interleaver.
